(19) United States
(12) Patent Application Publication
(10) Pub. No.: US 2014/0256945 A1
(43) Pub. Date: Sep. 11, 2014

(54) PHOSPHONIC ACID COMPOUNDS AS SPHINGOSINE-1-PHOSPHATE RECEPTOR MODULATORS

(71) Applicant: Allergan, Inc., Irvine, CA (US)

(72) Inventors: Phong X. Nguyen, Placentia, CA (US); Todd M. Heidelbaugh, Fountain Valley, CA (US)

(73) Assignee: Allergan, Inc., Irvine, CA (US)

(21) Appl. No.: 14/196,258

(22) Filed: Mar. 4, 2014

Related U.S. Application Data
(60) Provisional application No. 61/774,521, filed on Mar. 7, 2013.

(51) Int. Cl. C07F 9/38; C07F 9/58; C07F 9/655

(52) U.S. Cl. CPC C07F 9/3834; C07F 9/6551; C07F 9/588
USPC 546/22; 562/11; 562/15; 549/218

(57) ABSTRACT

The present invention relates to novel derivatives, processes for preparing them, pharmaceutical compositions containing them and their use as pharmaceuticals as modulators of sphingosine-1-phosphate receptors.

### RELATED APPLICATIONS

This application claims the benefit of U.S. Provisional Patent Application Ser. No. 61/774,521 filed Mar. 7, 2013, the disclosure of which is hereby incorporated in its entirety by reference.

### FIELD OF THE INVENTION

The present invention relates to novel aromatic derivatives, processes for preparing them, pharmaceutical compositions containing them and their use as pharmaceuticals as modulators of sphingosine-1-phosphate receptors. The invention also relates to the use of these compounds and their pharmaceutical compositions to treat disorders associated with sphingosine-1-phosphate (S1P) receptor modulation.

### BACKGROUND OF THE INVENTION

Sphingosine-1 phosphate is stored in relatively high concentrations in human platelets, which lack the enzymes responsible for its catabolism, and it is released into the blood stream upon activation of physiological stimuli, such as growth factors, cytokines, and receptor agonists and antigens. It may also have a critical role in platelet aggregation and thrombosis and could aggravate cardiovascular diseases. On the other hand the relatively high concentration of the metabolite in high-density lipoproteins (HDL) may have beneficial implications for atherogenesis. For example, there are recent suggestions that sphingosine-1-phosphate, together with other lysolipids such as sphingosylphosphorylcholine and lysosulfatide, are responsible for the beneficial clinical effects of HDL by stimulating the production of the potent antiatherogenic signaling molecule nitric oxide by the vascular endothelium. In addition, like lysophosphatidic acid, it is a marker for certain types of cancer, and there is evidence that its role in cell division or proliferation may have an influence on the development of cancers. These are currently topics that are attracting great interest amongst medical researchers, and the potential for therapeutic intervention in sphingosine-1-phosphate metabolism is under active investigation.

### SUMMARY OF THE INVENTION

We have now discovered a group of novel compounds which are potent sphingosine-1-phosphate modulators. As such, the compounds described herein are useful in treating a wide variety of disorders associated with modulation of sphingosine-1-phosphate receptors. The term “modulator” as used herein, includes but is not limited to: receptor agonist, antagonist, inverse agonist, inverse antagonist, partial agonist, partial antagonist.

This invention describes compounds of Formula I, which have sphingosine-1-phosphate receptor biological activity. The compounds in accordance with the present invention are thus of use in medicine, for example in the treatment of humans with diseases and conditions that are alleviated by S1P modulation.

In one embodiment of the invention, there are provided compounds having the Formula I below and pharmaceutically accepted salts thereof, its enantiomers, diastereoisomers, hydrates, solvates, crystal forms and individual isomers, tautomers or a pharmaceutically acceptable salt thereof,

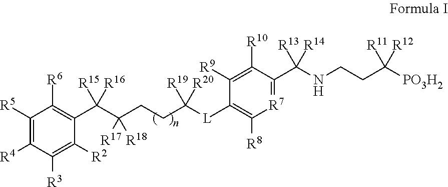

wherein:

n is 0 or 1;

L is —NR—, —C(O)NR¹—, —CR²³R²⁴— or —C≡C—;

R is H, or C₁₋₃ alkyl;

R¹ is H or C₁₋₃ alkyl;

R² is H, D, F, Cl, Br, C₁₋₄ alkyl, C₂₋₄ alkenyl, C₂₋₄ alkynyl, OH, NH₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R³ is H, D, F, Cl, Br, C₁₋₄ alkyl, C₂₋₄ alkenyl, C₂₋₄ alkynyl, OH, NH₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁴ is H, D, F, Cl, Br, C₁₋₄ alkyl, C₂₋₄ alkenyl, C₂₋₄ alkynyl, OH, NH₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁵ is H, D, F, Cl, Br, C₁₋₄ alkyl, C₂₋₄ alkenyl, C₂₋₄ alkynyl; OH, NH₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁶ is H, D, F, Cl, Br, C₁₋₄ alkyl, C₂₋₄ alkenyl, C₂₋₄ alkynyl, OH, NH₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁷ is N or CR^{7a};

R^{7a} is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁸ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁹ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R¹⁰ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²¹;

R¹¹ is H, D, F or C₁₋₄ alkyl;

R¹² is H, D, F or C₁₋₄ alkyl;

R¹³ is H, D, F, C₁₋₄ alkyl, C₁₋₄perfluoroalkyl, or together with R¹⁴ can form a 3 to 6 membered ring cycloalkyl or heterocycle;

R¹⁴ is H, D, F, C₁₋₄ alkyl, C₁₋₄perfluoroalkyl, or together with R¹³ can form a 3 to 6 membered ring cycloalkyl or heterocycle;

R¹⁵ is H, D, F, C₁₋₄ alkyl or C₁₋₄perfluoroalkyl or together with R¹⁶ can form a 3 to 6 membered ring cycloalkyl or heterocycle;

R¹⁶ is H, D, F, C₁₋₄ alkyl or C₁₋₄perfluoroalkyl or together with R¹⁵ can form a 3 to 6 membered ring cycloalkyl or heterocycle;

R¹⁷ is H, D, F, C₁₋₄ alkyl, C₁₋₄perfluoroalkyl, or together with R¹⁸ can form a 3 to 6 membered ring cycloalkyl or heterocycle;

R¹⁸ is H, D, F, C₁₋₄ alkyl, C₁₋₄perfluoroalkyl, or together with R¹⁷ can form a 3 to 6 membered ring cycloalkyl or heterocycle;

R¹⁹ is H, D, F, C₁₋₄ alkyl, C₁₋₄perfluoroalkyl,

R²⁰ is H, D, F, C₁₋₄ alkyl, C₁₋₄perfluoroalkyl;

R²¹ is H, C₁₋₄ alkyl, OH, C₁₋₄perfluoroalkyl or N(R²⁵)₂;

R²² is H, C₁₋₄ alkyl, OH, C₁₋₄perfluoroalkyl or N(R²⁵)₂;

R²³ is H, D, F, C₁₋₄ alkyl, C₁₋₄perfluoroalkyl;

R²⁴ is H, D, F, C₁₋₄ alkyl, C₁₋₄perfluoroalkyl; and

R²⁵ is H or C₁₋₄ alkyl;

with the provisos:
when n is 1 then L is —NR—, or —CR²³R²⁴—;
when n is 0 then L is —C(O)NR¹— or —C≡C—.
In another aspect the invention provides a compound having Formula I wherein:

n is 1;

L is —CR²³R²⁴—;

R is H or C₁₋₃ alkyl;

R¹ is H or C₁₋₃ alkyl,

R² is H, D, F, Cl, Br, C₁₋₄ alkyl, C₂₋₄ alkenyl, C₂₋₄ alkynyl, OH, NH₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R³ is H, D, F, Cl, Br, C₁₋₄ alkyl, C₂₋₄ alkenyl, C₂₋₄ alkynyl, OH, NH₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁴ is H, D, F, Cl, Br, C₁₋₄ alkyl, C₂₋₄ alkenyl, C₂₋₄ alkynyl, OH, NH₂, C₁₋₄perfluoroalkyl, O(C₁₋₄)perfluoroalkyl, OCF₂H, OCF₂CF₂H, O(C₁₋₄ alkyl), ON, SO₂R²¹ or C(O)R²²;

R⁵ is H, D, F, Cl, Br, C₁₋₄ alkyl, C₂₋₄ alkenyl, C₂₋₄ alkynyl; OH, NH₂, C₁₋₄perfluoroalkyl, O(C₁₋₄)perfluoroalkyl, OCF₂H, OCF₂CF₂H, O(C₁₋₄ alkyl), ON, SO₂R²¹ or C(O)R²²;

R⁶ is H, D, F, Cl, Br, C₁₋₄ alkyl, C₂₋₄ alkenyl, C₂₋₄ alkynyl, OH, NH₂, C₁₋₄perfluoroalkyl, O(C₁₋₄)perfluoroalkyl, OCF₂H, OCF₂CF₂H, O(C₁₋₄ alkyl), ON, SO₂R²¹ or C(O)R²²;

R⁷ is N;

R^{7a} is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), ON, SO₂R²¹ or C(O)R²²;

R⁸ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), ON, SO₂R²¹ or C(O)R²²;

R⁹ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), ON, SO₂R²¹ or C(O)R²²;

R¹⁰ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²¹;

R¹¹ is H, D, F or C₁₋₄ alkyl;

R¹² is H, D, F or C₁₋₄ alkyl;

R¹³ is H, D, F, C₁₋₄ alkyl, C₁₋₄perfluoroalkyl, or together with R¹⁴ can form a 3 to 6 membered ring cycloalkyl or heterocycle;

R¹⁴ is H, D, F, C₁₋₄ alkyl, C₁₋₄perfluoroalkyl, or together with R¹³ can form a 3 to 6 membered ring cycloalkyl or heterocycle;

R¹⁵ is H, D, F, C₁₋₄ alkyl or C₁₋₄perfluoroalkyl or together with R¹⁶ can form a 3 to 6 membered ring cycloalkyl or heterocycle;

R¹⁶ is H, D, F, C₁₋₄ alkyl or C₁₋₄perfluoroalkyl or together with R¹⁵ can form a 3 to 6 membered ring cycloalkyl or heterocycle;

R¹⁷ is H, D, F, C₁₋₄ alkyl, C₁₋₄perfluoroalkyl, or together with R¹⁸ can form a 3 to 6 membered ring cycloalkyl or heterocycle;

R¹⁸ is H, D, F, C₁₋₄ alkyl, C₁₋₄perfluoroalkyl, or together with R¹⁷ can form a 3 to 6 membered ring cycloalkyl or heterocycle;

R¹⁹ is H, D, F, C₁₋₄ alkyl, C₁₋₄perfluoroalkyl,

R²⁰ is H, D, F, C₁₋₄ alkyl, C₁₋₄perfluoroalkyl;

R²¹ is H, C₁₋₄ alkyl, OH, C₁₋₄perfluoroalkyl or N(R²⁵)₂;

R²² is H, C₁₋₄ alkyl, OH, C₁₋₄perfluoroalkyl or N(R²⁵)₂;

R²³ is H, D, F, C₁₋₄ alkyl, C₁₋₄perfluoroalkyl,

R²⁴ is H, D, F, C₁₋₄ alkyl, C₁₋₄perfluoroalkyl, and

R²⁵ is H or C₁₋₄ alkyl;

with the provisos:
when n is 1 then L is —NR—, or —CR²³R²⁴—;
when n is 0 then L is —C(O)NR¹— or —C≡C—.
In another aspect the invention provides a compound having Formula I wherein:

n is 1;

L is —CR²³R²⁴—;

R is H or C₁₋₃ alkyl;

R¹ is H or C₁₋₃ alkyl,

R² is H;

R³ is H;

R⁴ is H;

R⁵ is H;

R⁶ is H;

R⁷ is CR^{7a};

R^{7a} is H;

R⁸ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁹ is H;

R¹⁰ is H;

R¹¹ is H;

R¹² is H;

R¹³ is H;

R¹⁴ is H;

R¹⁵ is H;

R¹⁶ is H;

R¹⁷ is H;

R¹⁸ is H;

R¹⁹ is H;

R²⁰ is H;

R²¹ is H, C₁₋₄ alkyl, OH, C₁₋₄perfluoroalkyl or N(R²⁵)₂;

R²² is H, C₁₋₄ alkyl, OH, C₁₋₄perfluoroalkyl or N(R²⁵)₂;

R²³ is H;

R²⁴ is H; and

R²⁵ is H or C₁₋₄ alkyl.

In another aspect the invention provides a compound having Formula I wherein:

n is 1;

L is —NR—;

R is H, methyl, ethyl, n-propyl or isopropyl;

R¹ is H or C₁₋₃ alkyl;

R² is H;

R³ is H;

R⁴ is H;

R⁵ is H;

R⁶ is H;

R⁷ is CR^{7a};

R^{7a} is H;

R⁸ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁹ is H;

R¹⁰ is H;

R¹¹ is H;

R¹² is H;

R¹³ is H;

R¹⁴ is H;

R¹⁵ is H;

R¹⁶ is H;

R¹⁷ is H;

R¹⁸ is H;

R¹⁹ is H;

R²⁰ is H;

R²¹ is H, C₁₋₄ alkyl, OH, C₁₋₄perfluoroalkyl or N(R²⁵)₂;

R²² is H, C₁₋₄ alkyl, OH, C₁₋₄perfluoroalkyl or N(R²⁵)₂;

R²³ is H;

R²⁴ is H; and

R²⁵ is H or C₁₋₄ alkyl.

In another aspect the invention provides a compound having Formula I wherein:

n is 0;

### L is —C(O)NR¹—;

R is H or C₁₋₃ alkyl;

R¹ is H or C₁₋₃ alkyl,

R² is H;

R³ is H;

R⁴ is H;

R⁵ is H;

R⁶ is H;

R⁷ is CR^{7a};

R^{7a} is H;

R⁸ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁹ is H;

R¹⁰ is H;

R¹¹ is H;

R¹² is H;

R¹³ is H;

R¹⁴ is H;

R¹⁵ is H;

R¹⁶ is H;

R¹⁷ is H;

R¹⁸ is H;

R¹⁹ is H;

R²⁰ is H;

R²¹ is H, C₁₋₄ alkyl, OH, C₁₋₄perfluoroalkyl or N(R²⁵)₂;

R²² is H, C₁₋₄ alkyl, OH, C₁₋₄perfluoroalkyl or N(R²⁵)₂;

R²³ is H;

R²⁴ is H; and

R²⁵ is H or C₁₋₄ alkyl.

In another aspect the invention provides a compound having Formula I wherein:

n is 1;

L is —CR²³R²⁴—;

R is H or C₁₋₃ alkyl;

R¹ is H or C₁₋₃ alkyl,

R² is H;

R³ is H;

R⁴ is H;

R⁵ is H;

R⁶ is H;

R⁷ is CR^{7a};

R^{7a} is H;

R⁸ is H, D, F, Cl, Br, C₁₋₄ alkyl, C₂₋₄ alkenyl, C₂₋₄ alkynyl, OH, NH₂, NO₂, C₁₋₄ perfluoroalkyl, O(C₁₋₄)perfluoroalkyl, OCF₂H, OCF₂CF₂H, O(C₁₋₄ alkyl), CN, SO₂R²¹ or C(O)R²²;

R⁹ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R¹⁰ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R¹¹ is H;

R¹² is H;

R¹³ is H;

R¹⁴ is H;

R¹⁵ is H;

R¹⁶ is H;

R¹⁷ is H;

R¹⁸ is H;

R¹⁹ is H;

R²⁰ is H;

R²¹ is H, C₁₋₄ alkyl, OH, C₁₋₄perfluoroalkyl or N(R²⁵)₂;

R²² is H, C₁₋₄ alkyl, OH, C₁₋₄perfluoroalkyl or N(R²⁵)₂;

R²³ is H;

R²⁴ is H; and

R²⁵ is H or C₁₋₄ alkyl.

In another aspect the invention provides a compound having Formula I wherein:

n is 1;

L is —NR—;

R is H or C₁₋₃ alkyl;

R¹ is H or C₁₋₃ alkyl;

R² is H;

R³ is H;

R⁴ is H;

R⁵ is H;

R⁶ is H;

R⁷ is CR^{7a};

R^{7a} is H;

R⁸ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁹ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R¹⁰ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R¹¹ is H;

R¹² is H;

R¹³ is H;

R¹⁴ is H;

R¹⁵ is H;

R¹⁶ is H;

R¹⁷ is H;

R¹⁸ is H;

R¹⁹ is H;

R²⁰ is H;

R²¹ is H, C₁₋₄ alkyl, OH, C₁₋₄perfluoroalkyl or N(R²⁵)₂;

R²² is H, C₁₋₄ alkyl, OH, C₁₋₄perfluoroalkyl or N(R²⁵)₂;

R²³ is H;

R²⁴ is H; and

R²⁵ is H or C₁₋₄ alkyl.

In another aspect the invention provides a compound having Formula I wherein:

n is 0;

### L is —C(O)NR¹—;

R is H or C₁₋₃ alkyl;

R¹ is H or C₁₋₃ alkyl,

R² is H;

R³ is H;

R⁴ is H;

R⁵ is H;

R⁶ is H;

R⁷ is CR^{7a};

R^{7a} is H;

R⁸ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁹ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R¹⁰ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R¹¹ is H;

R¹² is H;

R¹³ is H;

R¹⁴ is H;

R¹⁵ is H;

R¹⁶ is H;

R¹⁷ is H;

R¹⁸ is H;

R¹⁹ is H;

R²⁰ is H;

R²¹ is H, C₁₋₄ alkyl, OH, C₁₋₄perfluoroalkyl or N(R²⁵)₂;

R²² is H, C₁₋₄ alkyl, OH, C₁₋₄perfluoroalkyl or N(R²⁵)₂;

R²³ is H;

R²⁴ is H; and

R²⁵ is H or C₁₋₄ alkyl.

In another aspect the invention provides a compound having Formula I wherein:

n is 1;

L is —CR²³R²⁴—;

R is H or C₁₋₃ alkyl;

R¹ is H or C₁₋₃ alkyl,

R² is H;

R³ is H;

R⁴ is H, D, F, Cl, Br, C₁₋₄ alkyl, C₂₋₄ alkenyl, C₂₋₄ alkynyl, OH, NH₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁵ is H;

R⁶ is H;

R⁷ is CR^{7a};

R^{7a} is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁸ is H;

R⁹ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R¹⁰ is H;

R¹¹ is H;

R¹² is H;

R¹³ is H;

R¹⁴ is H;

R¹⁵ is H;

R¹⁶ is H;

R¹⁷ is H;

R¹⁸ is H;

R¹⁹ is H;

R²⁰ is H;

R²¹ is H, C₁₋₄ alkyl, OH, C₁₋₄perfluoroalkyl or N(R²⁵)₂;

R²² is H, C₁₋₄ alkyl, OH, C₁₋₄perfluoroalkyl or N(R²⁵)₂;

R²³ is H or D;

R²⁴ is H or D; and

R²⁵ is H or C₁₋₄ alkyl.

In another aspect the invention provides a compound having Formula I wherein:

n is 1,

L is —CR²³R²⁴—;

R is H or C₁₋₃ alkyl;

R¹ is H or C₁₋₃ alkyl,

R² is H;

R³ is H;

R⁴ is H, D, F, Cl, Br, C₁₋₄ alkyl, C₂₋₄ alkenyl, C₂₋₄ alkynyl, OH, NH₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁵ is H;

R⁶ is H;

R⁷ is CR^{7a};

R^{7a} is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁸ is H;

R⁹ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R¹⁰ is H;

R¹¹ is H;

R¹² is H;

R¹³ is H;

R¹⁴ is H;

R¹⁵ is together with R¹⁶ can form a 3 to 6 membered ring cycloalkyl or heterocycle;

R¹⁶ is together with R¹⁵ can form a 3 to 6 membered ring cycloalkyl or heterocycle;

R¹⁷ is H;

R¹⁸ is H;

R¹⁹ is H;

R²⁰ is H;

R²¹ is H, C₁₋₄ alkyl, OH, C₁₋₄perfluoroalkyl or N(R²⁵)₂;

R²² is H, C₁₋₄ alkyl, OH, C₁₋₄perfluoroalkyl or N(R²⁵)₂;

R²³ is H;

R²⁴ is H; and

R²⁵ is H or C₁₋₄ alkyl.

In another aspect the invention provides a compound having Formula I wherein:

n is 1;

L is —CR²³R²⁴—;

R is H or C₁₋₃ alkyl;

R¹ is H or C₁₋₃ alkyl,

R² is H;

R³ is H;

R⁴ is H, D, F, Cl, Br, C₁₋₄ alkyl, C₂₋₄ alkenyl, C₂₋₄ alkynyl, OH, NH₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁵ is H;

R⁶ is H;

R⁷ is CR^{7a};

R^{7a} is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁸ is H;

R⁹ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R¹⁰ is H;

R¹¹ is H;

R¹² is H;

R¹³ is H;

R¹⁴ is H;

R¹⁵ is together with R¹⁶ can form a 3 to 6 membered ring heterocycle;

R¹⁶ is together with R¹⁵ can form a 3 to 6 membered ring heterocycle;

R¹⁷ is H;

R¹⁸ is H;

R¹⁹ is H;

R²⁰ is H;

R²¹ is H, C₁₋₄ alkyl, OH, C₁₋₄perfluoroalkyl or N(R²⁵)₂;

R²² is H, C₁₋₄ alkyl, OH, C₁₋₄perfluoroalkyl or N(R²⁵)₂;

R²³ is H;

R²⁴ is H; and

R²⁵ is H or C₁₋₄ alkyl.

In another aspect the invention provides a compound having Formula I wherein:

n is 1;

L is —CR²³R²⁴—;

R is H or C₁₋₃ alkyl;

R¹ is H or C₁₋₃ alkyl,

R² is H;

R³ is H;

R⁴ is H, D, F, Cl, Br, C₁₋₄ alkyl, C₂₋₄ alkenyl, C₂₋₄ alkynyl, OH, NH₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁵ is H;

R⁶ is H;

R⁷ is CR^{7a};

R^{7a} is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁸ is H;

R⁹ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R¹⁰ is H;

R¹¹ is H;

R¹² is H;

R¹³ is H;

R¹⁴ is H;

R¹⁵ is together with R¹⁶ can form a 3 to 6 membered ring cycloalkyl;

R¹⁶ is together with R¹⁵ can form a 3 to 6 membered ring cycloalkyl;

R¹⁷ is H;

R¹⁸ is H;

R¹⁹ is H;

R²⁰ is H;

R²¹ is H, C₁₋₄ alkyl, OH, C₁₋₄perfluoroalkyl or N(R²⁵)₂;

R²² is H, C₁₋₄ alkyl, OH, C₁₋₄perfluoroalkyl or N(R²⁵)₂;

R²³ is H;

R²⁴ is H; and

R²⁵ is H or C₁₋₄ alkyl.

In another aspect the invention provides a compound having Formula I wherein:

n is 1,

L is —CR²³R²⁴—;

R is H or C₁₋₃ alkyl;

R¹ is H or C₁₋₃ alkyl,

R² is H;

R³ is H;

R⁴ is H, D, F, Cl, Br, C₁₋₄ alkyl, C₂₋₄ alkenyl, C₂₋₄ alkynyl, OH, NH₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁵ is H;

R⁶ is H;

R⁷ is CR^{7a};

R^{7a} is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁸ is H;

R⁹ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R¹⁰ is H;

R¹¹ is H;

R¹² is H;

R¹³ is H;

R¹⁴ is H;

R¹⁵ is H, D, F, C₁₋₄ alkyl or C₁₋₄perfluoroalkyl;

R¹⁶ is H, D, F, C₁₋₄ alkyl or C₁₋₄perfluoroalkyl;

R¹⁷ is H;

R¹⁸ is H;

R¹⁹ is H;

R²⁰ is H;

R²¹ is H, C₁₋₄ alkyl, OH, C₁₋₄perfluoroalkyl or N(R²⁵)₂;

R²² is H, C₁₋₄ alkyl, OH, C₁₋₄perfluoroalkyl or N(R²⁵)₂;

R²³ is H;

R²⁴ is H; and

R²⁵ is H or C₁₋₄ alkyl.

In another aspect the invention provides a compound having Formula I wherein:

n is 1,

L is —CR²³R²⁴—;

R is H or C₁₋₃ alkyl;

R¹ is H or C₁₋₃ alkyl,

R² is H;

R³ is H;

R⁴ is H, D, F, Cl, Br, C₁₋₄ alkyl, C₂₋₄ alkenyl, C₂₋₄ alkynyl, OH, NH₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁵ is H;

R⁶ is H;

R⁷ is CR^{7a};

R^{7a} is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁸ is H;

R⁹ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R¹⁰ is H;

R¹¹ is H;

R¹² is H;

R¹³ is H;

R¹⁴ is H;

R¹⁵ is H, D, F, C₁₋₄ alkyl or C₁₋₄perfluoroalkyl;

R¹⁶ is H, D, F, C₁₋₄ alkyl or C₁₋₄perfluoroalkyl;

R¹⁷ is H, D, F, C₁₋₄ alkyl;

R¹⁸ is H, D, F, C₁₋₄ alkyl;

R¹⁹ is H;

R²⁰ is H;

R²¹ is H, C₁₋₄ alkyl, OH, C₁₋₄perfluoroalkyl or N(R²⁵)₂;

R²² is H, C₁₋₄ alkyl, OH, C₁₋₄perfluoroalkyl or N(R²⁵)₂;

R²³ is H;

R²⁴ is H; and

R²⁵ is H or C₁₋₄ alkyl.

In another aspect the invention provides a compound having Formula I wherein:

n is 0;

L is —C≡C—;

R is H or C₁₋₃ alkyl;

R¹ is H or C₁₋₃ alkyl,

R² is H;

R³ is H;

R⁴ is H;

R⁵ is H;

R⁶ is H;

R⁷ is CR^{7a};

R^{7a} is H;

R⁸ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;

R⁹ is H;

R¹⁰ is H;

R¹¹ is H;

R¹² is H;

R¹³ is H;

R¹⁴ is H;

R¹⁵ is H;

R¹⁶ is H;

R¹⁷ is H;

R¹⁸ is H;

R¹⁹ is H;

R²⁰ is H;

R²¹ is H, C₁₋₄ alkyl, OH, C₁₋₄perfluoroalkyl or N(R²⁵)₂;

R²² is H, C₁₋₄ alkyl, OH, C₁₋₄perfluoroalkyl or N(R²⁵)₂;

R²³ is H or D,

R²⁴ is H or D; and

R²⁵ is H or C₁₋₄ alkyl.

The term “alkyl”, as used herein, refers to saturated, monovalent hydrocarbon moieties having linear or branched moieties or combinations thereof and containing 1 to 6 carbon atoms. One methylene (—CH₂—) group, of the alkyl can be replaced by oxygen, sulfur, sulfoxide, nitrogen, carbonyl, carboxyl, sulfonyl, or by a divalent C₃₋₆ cycloalkyl. Alkyl groups can be substituted by halogen, amino, hydroxyl, cycloalkyl, amino, carboxylic acid, phosphonic acid groups, sulphonic acid groups, phosphoric acid.

The term “perfluoroalkyl” groups as used herein, refers to alkyl chains containing 1 to 4 carbon atoms wherein all the hydrogen atoms have been replaced by fluorine atoms on the carbon chain.

The term “alkylene”, as used herein, refers to saturated, divalent hydrocarbon moieties having linear or branched moieties or combinations thereof and containing 2 to 4 carbon atoms. One methylene (—CH₂—) group of the alkylene can be replaced by oxygen, sulfur, sulfoxide, nitrogen, carbonyl, carboxyl, sulfonyl.

The term “cycloalkyl”, as used herein, refers to a monovalent or divalent group of 3 to 8 carbon atoms, or 3 to 6 carbon atoms, derived from a saturated cyclic hydrocarbon. Cycloalkyl groups can be monocyclic or polycyclic. Cycloalkyl can be substituted by 1 to 3 C₁₋₃ alkyl groups or 1 or 2 halogens.

The term “heterocycle” as used herein, refers to a 3 to 8 membered ring, or a 3 to 6 membered ring which can be aromatic or non-aromatic, saturated or unsaturated, containing at least one heteroatom selected form oxygen, nitrogen, sulfur, or combinations of at least two thereof, interrupting the carbocyclic ring structure. Heterocycles can be substituted by 1 to 3 C₁₋₃ alkyl groups or 1 or 2 halogens.

The term “cycloalkenyl”, as used herein, refers to a monovalent or divalent group of 5 to 8 carbon atoms, preferably 3 to 6 carbon atoms derived from a saturated cycloalkyl having one double bond. Cycloalkenyl groups can be monocyclic or polycyclic. Cycloalkenyl groups can be substituted by C₁₋₃ alkyl groups or halogens.

The term “halogen”, as used herein, refers to an atom of chlorine, bromine, fluorine, iodine.

The term “alkenyl”, as used herein, refers to a monovalent or divalent hydrocarbon radical having 2 to 6 carbon atoms, derived from a saturated alkyl, having at least one double bond. C₂₋₆ alkenyl can be in the E or Z configuration. Alkenyl groups can be substituted by C₁₋₃ alkyl.

The term “alkynyl”, as used herein, refers to a monovalent or divalent hydrocarbon radical having 2 to 6 carbon atoms, derived from a saturated alkyl, having at least one triple bond.

The term “hydroxyl” as used herein, represents a group of formula “OH”.
The term “carbonyl” as used herein, represents a group of formula “—C═O”.
The term “carboxyl” as used herein, represents a group of formula “—C(O)O—”.
The term “sulfonyl” as used herein, represents a group of formula “—SO₂”.
The term “sulfate” as used herein, represents a group of formula “—O—S(O)₂—O—”.
The term “carboxylic acid” as used herein, represents a group of formula “—C(O)OH”.
The term “sulfoxide” as used herein, represents a group of formula “—S═O”.
The term “phosphonic acid” as used herein, represents a group of formula “—P(O)(OH)₂”.
The term “phosphoric acid” as used herein, represents a group of formula “—(O)P(O)(OH)₂”.
The term “sulphonic acid” as used herein, represents a group of formula “—S(O)₂OH”.
The term “amino” as used herein, represents a group of formula “—NH₂”.
The formula “H”, as used herein, represents a hydrogen atom.
The formula “O”, as used herein, represents an oxygen atom.
The formula “N”, as used herein, represents a nitrogen atom.
The formula “S”, as used herein, represents a sulfur atom.
Compounds of the invention are:
(3-{[3-fluoro-4-(6-phenylhex-1-yn-1-yl)benzyl]amino}propyl)phosphonic acid;
(3-{[3-fluoro-4-(6-phenylhex-1-yn-1-yl)benzyl]amino}propyl)phosphonic acid;
(3-{[3-methyl-4-(6-phenylhex-1-yn-1-yl)benzyl]amino}propyl)phosphonic acid;
(3-{[4-(6-phenylhex-1-yn-1-yl)benzyl]amino}propyl)phosphonic acid;
(3-{[3-bromo-4-(6-phenylhex-1-yn-1-yl)benzyl]amino}propyl)phosphonic acid;
(3-{[3-fluoro-4-(6-phenylhexyl)benzyl]amino}propyl)phosphonic acid;
(3-{[3-methyl-4-(6-phenylhexyl)benzyl]amino}propyl)phosphonic acid;
(3-{[4-(6-phenylhexyl)-3-(trifluoromethyl)benzyl]amino}propyl)phosphonic acid;
(3-{[3-chloro-4-(6-phenylhexyl)benzyl]amino}propyl)phosphonic acid;
(3-{[4-(6-phenylhexyl)benzyl]amino}propyl)phosphonic acid;
(3-{[2,5-difluoro-4-(6-phenylhexyl)benzyl]amino}propyl)phosphonic acid;
[3-({3-bromo-4-[(5-phenylpentanoyl)amino]benzyl}amino)propyl]phosphonic acid;
(3-((2,5-difluoro-4-(6-(4-fluorophenyl)hexyl)benzyl)amino)propyl)phosphonic acid;
(3-((3-fluoro-4-(6-(4-fluorophenyl)hexyl)benzyl)amino)propyl)phosphonic acid;
(3-((2,5-difluoro-4-(6-(3-fluorophenyl)hexyl)benzyl)amino)propyl)phosphonic acid;
(3-((2,5-difluoro-4-(6-(2-fluorophenyl)hexyl)benzyl)amino)propyl)phosphonic acid;
(3-((2-bromo-5-fluoro-4-(6-phenylhexyl)benzyl)amino)propyl)phosphonic acid;
(3-((5-fluoro-2-methyl-4-(6-phenylhexyl)benzyl)amino)propyl)phosphonic acid;
(3-((5-chloro-2-fluoro-4-(6-phenylhexyl)benzyl)amino)propyl)phosphonic acid;
(3-((5-bromo-2-fluoro-4-(6-phenylhexyl)benzyl)amino)propyl)phosphonic acid;
(3-((2-fluoro-5-methyl-4-(6-phenylhexyl)benzyl)amino)propyl)phosphonic acid;
(3-(((5-(6-phenylhexyl)pyridin-2-yl)methyl)amino)propyl)phosphonic acid;
(3-(((4-fluoro-5-(6-phenylhexyl)pyridin-2-yl)methyl)amino)propyl)phosphonic acid;
(3-((2-chloro-5-fluoro-4-(6-(4-fluorophenyl)hexyl)benzyl)amino)propyl)phosphonic acid;
(3-((2-bromo-5-fluoro-4-(6-(4-fluorophenyl)hexyl)benzyl)amino)propyl)phosphonic acid;
(3-((5-fluoro-4-(6-(4-fluorophenyl)hexyl)-2-methylbenzyl)amino)propyl) phosphonic acid;
(3-((5-chloro-2-fluoro-4-(6-(4-fluorophenyl)hexyl)benzyl)amino)propyl)phosphonic acid;
(3-((5-bromo-2-fluoro-4-(6-(4-fluorophenyl)hexyl)benzyl)amino)propyl)phosphonic acid;
(3-((2-fluoro-4-(6-(4-fluorophenyl)hexyl)-5-methylbenzyl)amino)propyl)phosphonic acid;
(3-(((4-fluoro-5-(6-(4-fluorophenyl)hexyl)pyridin-2-yl)methyl)amino)propyl)phosphonic acid;
(3-(((5-(6-(4-fluorophenyl)hexyl)pyridin-2-yl)methyl)amino)propyl)phosphonic acid;
(3-((4-(5-(1-phenylcyclohexyl)pentyl)benzyl)amino)propyl)phosphonic acid;
(3-((4-(6-methyl-6-phenylheptyl)benzyl)amino)propyl)phosphonic acid;
(3-((4-(5-(1-phenylcyclopentyl)pentyl)benzyl)amino)propyl)phosphonic acid;
(3-((4-(5-(3-phenyloxetan-3-yl)pentyl)benzyl)amino)propyl)phosphonic acid;
(3-((2,5-difluoro-4-(5-(1-phenylcyclohexyl)pentyl)benzyl)amino)propyl)phosphonic acid;
(3-((3-fluoro-4-(5-(1-phenylcyclohexyl)pentyl)benzyl)amino)propyl)phosphonic acid;
(3-((2,5-difluoro-4-(6-methyl-6-phenylheptyl)benzyl)amino)propyl)phosphonic acid;
(3-((2,5-difluoro-4-(5-(1-phenylcyclopentyl)pentyl)benzyl)amino)propyl) phosphonic acid;
(3-((2,5-difluoro-4-(5-(3-phenyloxetan-3-yl)pentyl)benzyl)amino)propyl)phosphonic acid;
(3-((4-(5,5-dimethyl-6-phenylhexyl)-3-fluorobenzyl)amino)propyl)phosphonic acid;
(3-{[3-fluoro-4-(6-phenylhexyl)benzyl]amino}propyl)phosphonic acid-d₂;
(3-{[3-chloro-4-(6-phenylhexyl)benzyl]amino}propyl)phosphonic acid-d₂;
(3-((3-chloro-2,5-difluoro-4-(6-(4-fluorophenyl)-6-methylheptyl)benzyl)amino) propyl)phosphonic acid;
(3-((3-chloro-4-((5-(4-fluorophenyl)-5-methylhexyl)amino)benzyl)amino)propyl)phosphonic acid;
(3-((3-chloro-4-((4,4-dimethyl-5-phenylpentyl)amino)benzyl)amino)propyl)phosphonic acid;
(3-((3-chloro-4-((4-(3-phenyloxetan-3-yl)butyl)amino)benzyl)amino)propyl)phosphonic acid;
(3-((3-chloro-4-((4-(1-phenylcyclopentyl)butyl)amino)benzyl)amino)propyl)phosphonic acid;
(3-((3-chloro-4-((4-(1-phenylcyclohexyl)butyl)amino)benzyl)amino)propyl)phosphonic acid;
(3-(((4-chloro-5-((5-phenylpentyl)amino)pyridin-2-yl)methyl)amino)propyl)phosphonic acid;
(3-(((4-chloro-5-((5-(4-fluorophenyl)pentyl)amino)pyridin-2-yl)methyl)amino)propyl)phosphonic acid;
(3-((5-chloro-2-fluoro-4-((5-(4-fluorophenyl)pentyl)amino)benzyl)amino)propyl)phosphonic acid;
(3-((3-chloro-4-((5-(4-fluorophenyl)pentyl)amino)benzyl)amino)propyl)phosphonic acid;
(3-((3-chloro-4-((5-(3-fluorophenyl)pentyl)amino)benzyl)amino)propyl)phosphonic acid;
(3-((3-chloro-4-(6-(4-fluorophenyl)-6-methylheptyl)benzyl)amino)propyl)phosphonic acid;
(3-((3-chloro-4-(5,5-dimethyl-6-phenylhexyl)benzyl)amino)propyl)phosphonic acid;
(3-((3-chloro-4-(5-(3-phenyloxetan-3-yl)pentyl)benzyl)amino)propyl)phosphonic acid;
(3-((3-chloro-4-(5-(1-phenylcyclopentyl)pentyl)benzyl)amino)propyl)phosphonic acid;
(3-((3-chloro-4-(5-(1-phenylcyclohexyl)pentyl)benzyl)amino)propyl)phosphonic acid;
(3-(((4-chloro-5-(6-phenylhexyl)pyridin-2-yl)methyl)amino)propyl)phosphonic acid;
(3-(((4-chloro-5-(6-(4-fluorophenyl)hexyl)pyridin-2-yl)methyl)amino)propyl)phosphonic acid;
(3-((5-chloro-2-fluoro-4-(6-(4-fluorophenyl)hexyl)benzyl)amino)propyl)phosphonic acid;
(3-((3-chloro-4-(6-(4-fluorophenyl)hexyl)benzyl)amino)propyl)phosphonic acid;
(3-((3-chloro-4-(6-(3-fluorophenyl)hexyl)benzyl)amino)propyl)phosphonic acid;
(3-((3-chloro-4-((5-(2-fluorophenyl)pentyl)amino)benzyl)amino)propyl)phosphonic acid.
(3-((4-(6-phenylhexyl)-3-(trifluoromethoxy)benzyl)amino)propyl)phosphonic acid;
(3-((4-(6-(p-tolyl)hexyl)-3-(trifluoromethoxy)benzyl)amino)propyl)phosphonic acid;
(3-((4-(5-(1-phenylcyclohexyl)pentyl)-3-(trifluoromethoxy)benzyl)amino)propyl)phosphonic acid;
(3-((3-(perfluoroethyl)-4-(6-phenylhexyl)benzyl)amino)propyl)phosphonic acid;
(3-((3-(perfluoroethyl)-4-(6-(p-tolyl)hexyl)benzyl)amino)propyl)phosphonic acid;
(3-((3-(perfluoroethyl)-4-(5-(1-phenylcyclohexyl)pentyl)benzyl)amino)propyl)phosphonic acid;
(3-((4-((5-phenylpentyl)amino)-3-(trifluoromethoxy)benzyl)amino)propyl)phosphonic acid;
(3-((4-((5-(p-tolyl)pentyl)amino)-3-(trifluoromethoxy)benzyl)amino)propyl)phosphonic acid;
(3-((4-((4-(1-phenylcyclohexyl)butyl)amino)-3-(trifluoromethoxy)benzyl)amino)propyl)phosphonic acid;
(3-((3-(perfluoroethyl)-4-((5-phenylpentyl)amino)benzyl)amino)propyl)phosphonic acid;
(3-((3-(perfluoroethyl)-4-((5-(p-tolyl)pentyl)amino)benzyl)amino)propyl)phosphonic acid;
(3-((3-(perfluoroethyl)-4-((4-(1-phenylcyclohexyl)butyl)amino)benzyl)amino)propyl)phosphonic acid;
(3-((4-(6-(4-fluorophenyl)hexyl)-3-(trifluoromethoxy)benzyl)amino)propyl)phosphonic acid;
(3-((4-(6-(4-fluorophenyl)hexyl)-3-(perfluoroethyl)benzyl)amino)propyl)phosphonic acid;
(3-((4-(5-(1-(4-fluorophenyl)cyclohexyl)pentyl)-3-(trifluoromethoxy)benzyl)amino)propyl)phosphonic acid;
(3-((4-(5-(1-(4-fluorophenyl)cyclohexyl)pentyl)-3-(perfluoroethyl)benzyl)amino)propyl)phosphonic acid;
(3-((4-((5-(4-fluorophenyl)pentyl)amino)-3-(trifluoromethoxy)benzyl)amino)propyl)phosphonic acid;
(3-((4-((5-(4-fluorophenyl)pentyl)amino)-3-(perfluoroethyl)benzyl)amino)propyl)phosphonic acid;
(3-((4-((4-(1-(4-fluorophenyl)cyclohexyl)butyl)amino)-3-(trifluoromethoxy)benzyl)amino)propyl)phosphonic acid;
(3-((4-((4-(1-(4-fluorophenyl)cyclohexyl)butyl)amino)-3-(perfluoroethyl)benzyl)amino)propyl)phosphonic acid;
(3-((4-(6-(4-fluorophenyl)hexyl)-3-(trifluoromethyl)benzyl)amino)propyl)phosphonic acid;
(3-((4-(6-(p-tolyl)hexyl)-3-(trifluoromethyl)benzyl)amino)propyl)phosphonic acid;
(3-((4-(5-(1-phenylcyclohexyl)pentyl)-3-(trifluoromethyl)benzyl)amino)propyl)phosphonic acid;
(3-((4-(5-(1-(4-fluorophenyl)cyclohexyl)pentyl)-3-(trifluoromethyl)benzyl)amino)propyl)phosphonic acid;
(3-((4-((5-phenylpentyl)amino)-3-(trifluoromethyl)benzyl)amino)propyl)phosphonic acid;
(3-((4-((5-(4-fluorophenyl)pentyl)amino)-3-(trifluoromethyl)benzyl)amino)propyl)phosphonic acid;
(3-((4-((5-(p-tolyl)pentyl)amino)-3-(trifluoromethyl)benzyl)amino)propyl)phosphonic acid;
(3-((4-((4-(1-phenylcyclohexyl)butyl)amino)-3-(trifluoromethyl)benzyl)amino)propyl)phosphonic acid;
(3-((4-((4-(1-(4-fluorophenyl)cyclohexyl)butyl)amino)-3-(trifluoromethyl)benzyl)amino)propyl)phosphonic acid;
(3-((3-fluoro-4-(methyl(5-phenylpentyl)amino)benzyl)amino)propyl)phosphonic acid;
(3-((4-(ethyl(5-phenylpentyl)amino)-3-fluorobenzyl)amino)propyl)phosphonic acid;
(3-((3-chloro-4-(methyl(5-phenylpentyl)amino)benzyl)amino)propyl)phosphonic acid;
(3-((3-chloro-4-(ethyl(5-phenylpentyl)amino)benzyl)amino)propyl)phosphonic acid;
(3-((3-methyl-4-(methyl(5-phenylpentyl)amino)benzyl)amino)propyl)phosphonic acid;
(3-((4-(ethyl(5-phenylpentyl)amino)-3-methylbenzyl)amino)propyl)phosphonic acid;
(3-((4-(ethyl(5-(4-fluorophenyl)pentyl)amino)-3-fluorobenzyl)amino)propyl)phosphonic acid;
(3-((3-chloro-4-(ethyl(5-(4-fluorophenyl)pentyl)amino)benzyl)amino)propyl)phosphonic acid; and
(3-((4-(ethyl(5-(4-fluorophenyl)pentyl)amino)-3-methylbenzyl)amino)propyl)phosphonic acid.

Some compounds of Formula I and some of their intermediates may have at least one stereogenic center in their structure. This stereogenic center may be present in an R or S configuration, said R and S notation is used in correspondence with the rules described in Pure Appli. Chem. (1976), 45, 11-13.

The term “pharmaceutically acceptable salts” refers to salts or complexes that retain the desired biological activity of the above identified compounds and exhibit minimal or no undesired toxicological effects. The “pharmaceutically acceptable salts” according to the invention include therapeutically active, non-toxic base or acid salt forms, which the compounds of Formula I are able to form.

The acid addition salt form of a compound of Formula I that occurs in its free form as a base can be obtained by treating the free base with an appropriate acid such as an inorganic acid, for example, an inorganic acid, such as hydrochloric acid, hydrobromic acid, sulfuric acid, phosphoric acid, nitric acid and the like; or an organic acid such as for example, acetic, hydroxyacetic, propanoic, lactic, pyruvic, malonic, fumaric acid, maleic acid, oxalic acid, tartaric acid, succinic acid, malic acid, ascorbic acid, benzoic acid, tannic acid, pamoic acid, citric, methylsulfonic, ethanesulfonic, benzenesulfonic, formic and the like (Handbook of Pharmaceutical Salts, P. Heinrich Stahl & Camille G. Wermuth (Eds), Verlag Helvetica Chimica Acta-Zürich, 2002, 329-345).

Compounds of Formula I and their salts can be in the form of a solvate, which is included within the scope of the present invention. Such solvates include for example hydrates, alcoholates and the like.

With respect to the present invention reference to a compound or compounds, is intended to encompass that compound in each of its possible isomeric forms and mixtures thereof unless the particular isomeric form is referred to specifically.

Compounds according to the present invention may exist in different polymorphic forms. Although not explicitly indicated in the above formula, such forms are intended to be included within the scope of the present invention.

The compounds of the invention are indicated for use in treating or preventing conditions in which there is likely to be a component involving the sphingosine-1-phosphate receptors.

In another embodiment, there are provided pharmaceutical compositions including at least one compound of the invention in a pharmaceutically acceptable carrier.

In a further embodiment of the invention, there are provided methods for treating disorders associated with modulation of sphingosine-1-phosphate receptors. Such methods can be performed, for example, by administering to a subject in need thereof a pharmaceutical composition containing a therapeutically effective amount of at least one compound of the invention.

These compounds are useful for the treatment of mammals, including humans, with a range of conditions and diseases that are alleviated by S1P modulation: not limited to the treatment of diabetic retinopathy, other retinal degenerative conditions, dry eye, angiogenesis and wounds.

Therapeutic utilities of S1P modulators are ocular diseases, such as but not limited to: wet and dry age-related macular degeneration, diabetic retinopathy, retinopathy of prematurity, retinal edema, geographic atrophy, glaucomatous optic neuropathy, chorioretinopathy, hypertensive retinopathy, ocular ischemic syndrome, prevention of inflammation-induced fibrosis in the back of the eye, various ocular inflammatory diseases including uveitis, scleritis, keratitis, and retinal vasculitis; or systemic vascular barrier related diseases such as but not limited to: various inflammatory diseases, including acute lung injury, its prevention, sepsis, tumor metastasis, atherosclerosis, pulmonary edemas, and ventilation-induced lung injury; or autoimmune diseases and immunosuppression such as but not limited to: rheumatoid arthritis, Crohn's disease, Graves' disease, inflammatory bowel disease, multiple sclerosis, Myasthenia gravis, Psoriasis, ulcerative colitis, autoimmune uveitis, renal ischemia/perfusion injury, contact hypersensitivity, atopic dermatitis, and organ transplantation; or allergies and other inflammatory diseases such as but not limited to: urticaria, bronchial asthma, and other airway inflammations including pulmonary emphysema and chronic obstructive pulmonary diseases; or cardiac protection such as but not limited to: ischemia reperfusion injury and atherosclerosis; or wound healing such as but not limited to: scar-free healing of wounds from cosmetic skin surgery, ocular surgery, GI surgery, general surgery, oral injuries, various mechanical, heat and burn injuries, prevention and treatment of photoaging and skin ageing, and prevention of radiation-induced injuries; or bone formation such as but not limited to: treatment of osteoporosis and various bone fractures including hip and ankles; or anti-nociceptive activity such as but not limited to: visceral pain, pain associated with diabetic neuropathy, rheumatoid arthritis, chronic knee and joint pain, tendonitis, osteoarthritis, neuropathic pains; or central nervous system neuronal activity in Alzheimer's disease, age-related neuronal injuries; or in organ transplant such as renal, corneal, cardiac or adipose tissue transplant; inflammatory skin diseases, scleroderma, dermatomyositis, atopic dermatitis, lupus erythematosus, epidermolysis bullosa, and bullous pemphigold. Topical use of S1P (sphingosine) compounds is of use in the treatment of various acne diseases, acne vulgaris, and rosacea.

In still another embodiment of the invention, there are provided methods for treating disorders associated with modulation of sphingosine-1-phosphate receptors. Such methods can be performed, for example, by administering to a subject in need thereof a therapeutically effective amount of at least one compound of the invention, or any combination thereof, or pharmaceutically acceptable salts, hydrates, solvates, crystal forms and individual isomers, enantiomers, and diastereomers thereof.

The present invention concerns the use of a compound of Formula I or a pharmaceutically acceptable salt thereof, for the manufacture of a medicament for the treatment of ocular disease, wet and dry age-related macular degeneration, diabetic retinopathy, retinopathy of prematurity, retinal edema, geographic atrophy, glaucomatous optic neuropathy, chorioretinopathy, hypertensive retinopathy, ocular ischemic syndrome, prevention of inflammation-induced fibrosis in the back of the eye, various ocular inflammatory diseases including uveitis, scleritis, keratitis, and retinal vasculitis; or systemic vascular barrier related diseases, various inflammatory diseases, including acute lung injury, its prevention, sepsis, tumor metastasis, atherosclerosis, pulmonary edemas, and ventilation-induced lung injury; or autoimmune diseases and immunosuppression, rheumatoid arthritis, Crohn's disease, Graves' disease, inflammatory bowel disease, multiple sclerosis, Myasthenia gravis, Psoriasis, ulcerative colitis, autoimmune uveitis, renal ischemia/perfusion injury, contact hypersensitivity, atopic dermatitis, and organ transplantation; or allergies and other inflammatory diseases, urticaria, bronchial asthma, and other airway inflammations including pulmonary emphysema and chronic obstructive pulmonary diseases; or cardiac protection, ischemia reperfusion injury and atherosclerosis; or wound healing, scar-free healing of wounds from cosmetic skin surgery, ocular surgery, GI surgery, general surgery, oral injuries, various mechanical, heat and burn injuries, prevention and treatment of photoaging and skin ageing, and prevention of radiation-induced injuries; or bone formation, treatment of osteoporosis and various bone fractures including hip and ankles; or anti-nociceptive activity, visceral pain, pain associated with diabetic neuropathy, rheumatoid arthritis, chronic knee and joint pain, tendonitis, osteoarthritis, neuropathic pains; or central nervous system neuronal activity in Alzheimer's disease, age-related neuronal injuries; or in organ transplant such as renal, corneal, cardiac or adipose tissue transplant; inflammatory skin diseases, scleroderma, dermatomyositis, atopic dermatitis, lupus erythematosus, epidermolysis bullosa, and bullous pemphigoid.

The actual amount of the compound to be administered in any given case will be determined by a physician taking into account the relevant circumstances, such as the severity of the condition, the age and weight of the patient, the patient's general physical condition, the cause of the condition, and the route of administration.

The patient will be administered the compound orally in any acceptable form, such as a tablet, liquid, capsule, powder and the like, or other routes may be desirable or necessary, particularly if the patient suffers from nausea. Such other routes may include, without exception, transdermal, parenteral, subcutaneous, intranasal, via an implant stent, intrathecal, intravitreal, topical to the eye, back to the eye, intramuscular, intravenous, and intrarectal modes of delivery. Additionally, the formulations may be designed to delay release of the active compound over a given period of time, or to carefully control the amount of drug released at a given time during the course of therapy.

In another embodiment of the invention, there are provided pharmaceutical compositions including at least one compound of the invention in a pharmaceutically acceptable carrier thereof. The phrase “pharmaceutically acceptable” means the carrier, diluent or excipient must be compatible with the other ingredients of the formulation and not deleterious to the recipient thereof.

Pharmaceutical compositions of the present invention can be used in the form of a solid, a solution, an emulsion, a dispersion, a patch, a micelle, a liposome, and the like, wherein the resulting composition contains one or more compounds of the present invention, as an active ingredient, in admixture with an organic or inorganic carrier or excipient suitable for enteral or parenteral applications. Invention compounds may be combined, for example, with the usual non-toxic, pharmaceutically acceptable carriers for tablets, pellets, capsules, suppositories, solutions, emulsions, suspensions, and any other form suitable for use. The carriers which can be used include glucose, lactose, gum acacia, gelatin, mannitol, starch paste, magnesium trisilicate, talc, corn starch, keratin, colloidal silica, potato starch, urea, medium chain length triglycerides, dextrans, and other carriers suitable for use in manufacturing preparations, in solid, semisolid, or liquid form. In addition auxiliary, stabilizing, thickening and coloring agents and perfumes may be used. Invention compounds are included in the pharmaceutical composition in an amount sufficient to produce the desired effect upon the process or disease condition.

Pharmaceutical compositions containing invention compounds may be in a form suitable for oral use, for example, as tablets, troches, lozenges, aqueous or oily suspensions, dispersible powders or granules, emulsions, hard or soft capsules, or syrups or elixirs. Compositions intended for oral use may be prepared according to any method known in the art for the manufacture of pharmaceutical compositions and such compositions may contain one or more agents selected from the group consisting of a sweetening agent such as sucrose, lactose, or saccharin, flavoring agents such as peppermint, oil of wintergreen or cherry, coloring agents and preserving agents in order to provide pharmaceutically elegant and palatable preparations. Tablets containing invention compounds in admixture with non-toxic pharmaceutically acceptable excipients may also be manufactured by known methods. The excipients used may be, for example, (1) inert diluents such as calcium carbonate, lactose, calcium phosphate or sodium phosphate; (2) granulating and disintegrating agents such as corn starch, potato starch or alginic acid; (3) binding agents such as gum tragacanth, corn starch, gelatin or acacia, and (4) lubricating agents such as magnesium stearate, stearic acid or talc. The tablets may be uncoated or they may be coated by known techniques to delay disintegration and absorption in the gastrointestinal tract and thereby provide a sustained action over a longer period. For example, a time delay material such as glyceryl monostearate or glyceryl distearate may be employed.

In some cases, formulations for oral use may be in the form of hard gelatin capsules wherein the invention compounds are mixed with an inert solid diluent, for example, calcium carbonate, calcium phosphate or kaolin. They may also be in the form of soft gelatin capsules wherein the invention compounds are mixed with water or an oil medium, for example, peanut oil, liquid paraffin or olive oil.

The pharmaceutical compositions may be in the form of a sterile injectable suspension. This suspension may be formulated according to known methods using suitable dispersing or wetting agents and suspending agents. The sterile injectable preparation may also be a sterile injectable solution or suspension in a non-toxic parenterally-acceptable diluent or solvent, for example, as a solution in 1,3-butanediol. Sterile, fixed oils are conventionally employed as a solvent or suspending medium. For this purpose any bland fixed oil may be employed including synthetic mono- or diglycerides, fatty acids (including oleic acid), naturally occurring vegetable oils like sesame oil, coconut oil, peanut oil, cottonseed oil, etc., or synthetic fatty vehicles like ethyl oleate or the like. Buffers, preservatives, antioxidants, and the like can be incorporated as required.

Invention compounds may also be administered in the form of suppositories for rectal administration of the drug. These compositions may be prepared by mixing the invention compounds with a suitable non-irritating excipient, such as cocoa butter, synthetic glyceride esters of polyethylene glycols, which are solid at ordinary temperatures, but liquefy and/or dissolve in the rectal cavity to release the drug.

The compounds of the invention may also be administered as pharmaceutical compositions in a form suitable for topical use, for example, as oily suspensions, as solutions or suspensions in aqueous liquids or nonaqueous liquids, or as oil-in-water or water-in-oil liquid emulsions.

Pharmaceutical compositions may be prepared by combining a therapeutically effective amount of at least one compound according to the present invention, or a pharmaceutically acceptable salt thereof, as an active ingredient with conventional ophthalmically acceptable pharmaceutical excipients and by preparation of unit dosage suitable for topical ocular use. The therapeutically efficient amount typically is between about 0.001 and about 5% (w/v), preferably about 0.001 to about 2.0% (w/v) in liquid formulations.

For ophthalmic application, preferably solutions are prepared using a physiological saline solution as a major vehicle. The pH of such ophthalmic solutions should preferably be maintained between 4.5 and 8.0 with an appropriate buffer system, a neutral pH being preferred but not essential. The formulations may also contain conventional pharmaceutically acceptable preservatives, stabilizers and surfactants.

Preferred preservatives that may be used in the pharmaceutical compositions of the present invention include, but are not limited to, benzalkonium chloride, chlorobutanol, thimerosal, phenylmercuric acetate and phenylmercuric nitrate.

A preferred surfactant is, for example, Tween 80. Likewise, various preferred vehicles may be used in the ophthalmic preparations of the present invention. These vehicles include, but are not limited to, polyvinyl alcohol, povidone, hydroxypropyl methyl cellulose, poloxamers, carboxymethyl cellulose, hydroxyethyl cellulose cyclodextrin and purified water.

Tonicity adjustors may be added as needed or convenient. They include, but are not limited to, salts, particularly sodium chloride, potassium chloride, mannitol and glycerin, or any other suitable ophthalmically acceptable tonicity adjustor.

Various buffers and means for adjusting pH may be used so long as the resulting preparation is ophthalmically acceptable. Accordingly, buffers include acetate buffers, citrate buffers, phosphate buffers and borate buffers. Acids or bases may be used to adjust the pH of these formulations as needed.

In a similar manner an ophthalmically acceptable antioxidant for use in the present invention includes, but is not limited to, sodium metabisulfite, sodium thiosulfate, acetylcysteine, butylated hydroxyanisole and butylated hydroxytoluene.

Other excipient components which may be included in the ophthalmic preparations are chelating agents. The preferred chelating agent is edentate disodium, although other chelating agents may also be used in place of or in conjunction with it.

The ingredients are usually used in the following amounts:

| Ingredient | Amount (% w/v) |
|---|---|
| active ingredient | about 0.001 to about 5 |
| preservative | 0-0.10 |
| vehicle | 0-40 |
| tonicity adjustor | 0-10 |
| buffer | 0.01-10 |
| pH adjustor | q.s. pH 4.5-7.8 |
| antioxidant | as needed |
| surfactant | as needed |
| purified water | to make 100% |

The actual dose of the active compounds of the present invention depends on the specific compound, and on the condition to be treated; the selection of the appropriate dose is well within the knowledge of the skilled artisan.

The ophthalmic formulations of the present invention are conveniently packaged in forms suitable for metered application, such as in containers equipped with a dropper, to facilitate application to the eye. Containers suitable for drop wise application are usually made of suitable inert, non-toxic plastic material, and generally contain between about 0.5 and about 15 ml solution. One package may contain one or more unit doses. Especially preservative-free solutions are often formulated in non-resealable containers containing up to about ten, preferably up to about five units doses, where a typical unit dose is from one to about 8 drops, preferably one to about 3 drops. The volume of one drop usually is about 20-35 μl.

Since individual subjects may present a wide variation in severity of symptoms and each drug has its unique therapeutic characteristics, the precise mode of administration and dosage employed for each subject is left to the discretion of the practitioner.

The compounds and pharmaceutical compositions described herein are useful as medicaments in mammals, including humans, for treatment of diseases and/or alleviations of conditions which are responsive to treatment by agonists or functional antagonists of sphingosine-1-phosphate receptors. Thus, in further embodiments of the invention, there are provided methods for treating a disorder associated with modulation of sphingosine-1-phosphate receptors. Such methods can be performed, for example, by administering to a subject in need thereof a pharmaceutical composition containing a therapeutically effective amount of at least one invention compound. As used herein, the term “therapeutically effective amount” means the amount of the pharmaceutical composition that will elicit the biological or medical response of a subject in need thereof that is being sought by the researcher, veterinarian, medical doctor or other clinician. In some embodiments, the subject in need thereof is a mammal. In some embodiments, the mammal is human.

The present invention concerns also processes for preparing the compounds of Formula I. The compounds of Formula I according to the invention can be prepared analogously to conventional methods as understood by the person skilled in the art of synthetic organic chemistry. The synthetic schemes set forth below, illustrate how compounds according to the invention can be made. Those skilled in the art will be able to routinely modify and/or adapt the following scheme to synthesize any compounds of the invention covered by Formula I.

In Scheme 1, aryl esters react with alkyne compounds in the presence of copper iodide and a palladium catalyst to give the corresponding aryl alkyne intermediate. This intermediate is reduced with a hydride reagent such as LAH or DIBAL to give the corresponding alcohol intermediate. An oxidation with an appropriate reagent such as MnO₂ forms the aldehyde. This aldehyde intermediate reacts with 3-aminopropylphosphonic acid followed by an appropriate hydride such as sodium borohydride in a reductive amination reaction to give a derivative of Formula I.

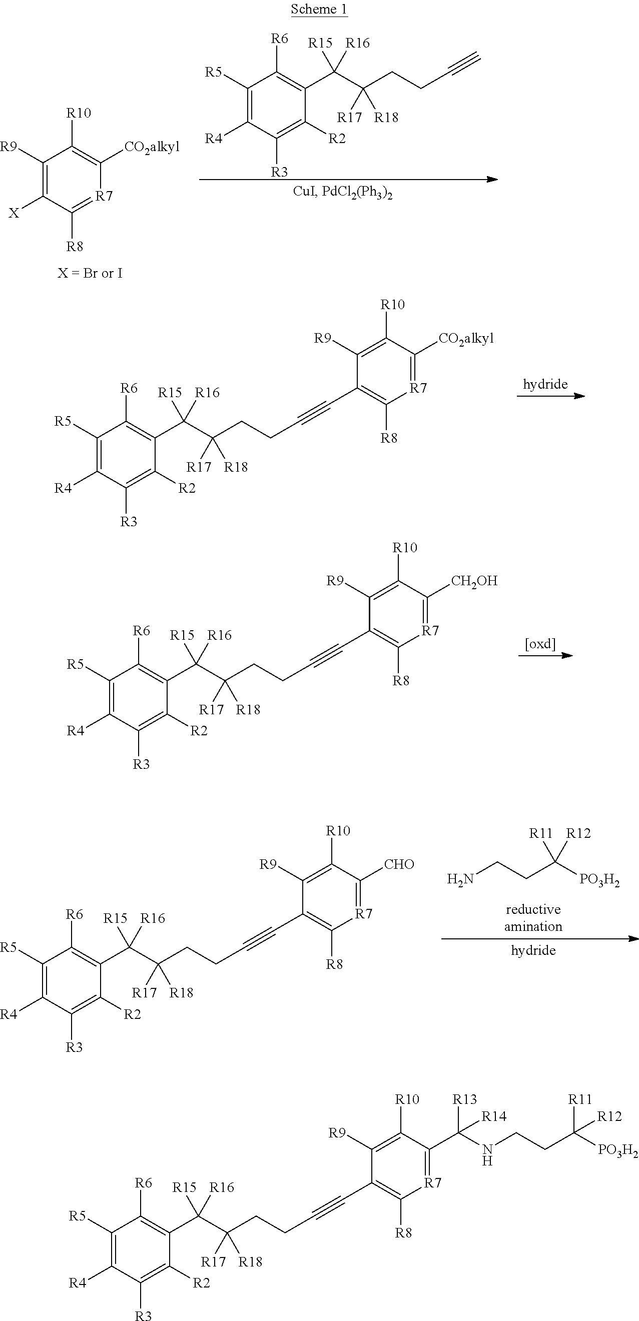

In Scheme 2, alkynes react with hydrogen in the presence of Pd or PtO₂ to give the corresponding intermediate. This intermediate is reduced with a hydride such as LAH or DIBAL and subsequently oxidized give the corresponding aldehyde intermediate. This aldehyde intermediate reacts with 3-aminopropylphosphonic acid followed by an appropriate hydride such as sodium borohydride in a reductive amination reaction to give a derivative of Formula I.

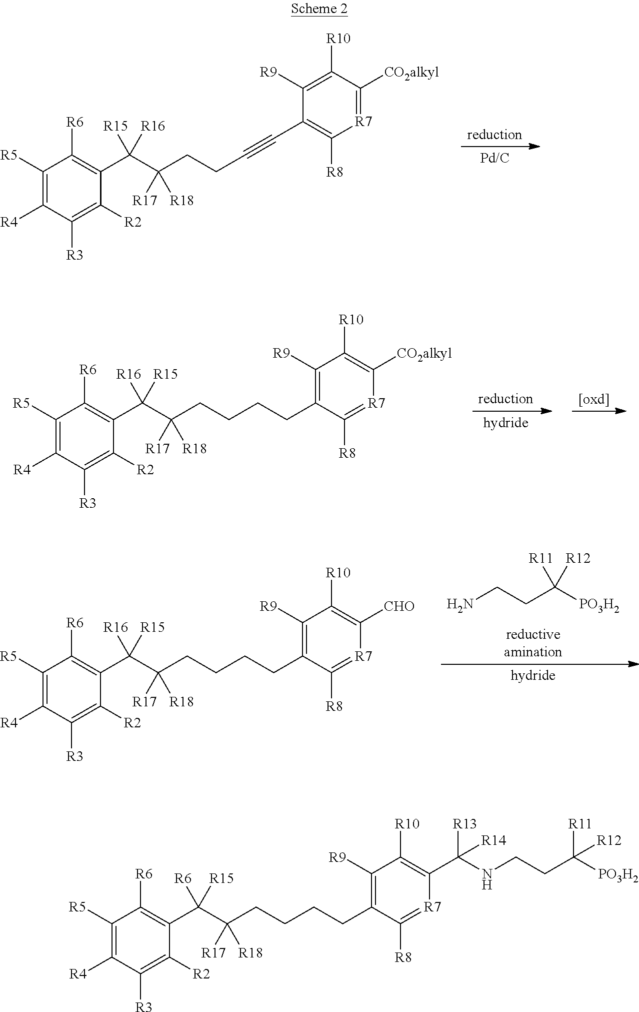

In Scheme 3, anilines are bonded to alkyls containing a terminal aryl ring to form amides or amines with coupling reagents (such as HATU) or treatment of the aniline with base to give the corresponding amine intermediate. This intermediate is subsequently oxidized to give the corresponding aldehyde intermediate. This aldehyde intermediate reacts with 3-aminopropylphosphonic acid followed by an appropriate hydride such as sodium borohydride in a reductive amination reaction to give a derivative of Formula I.

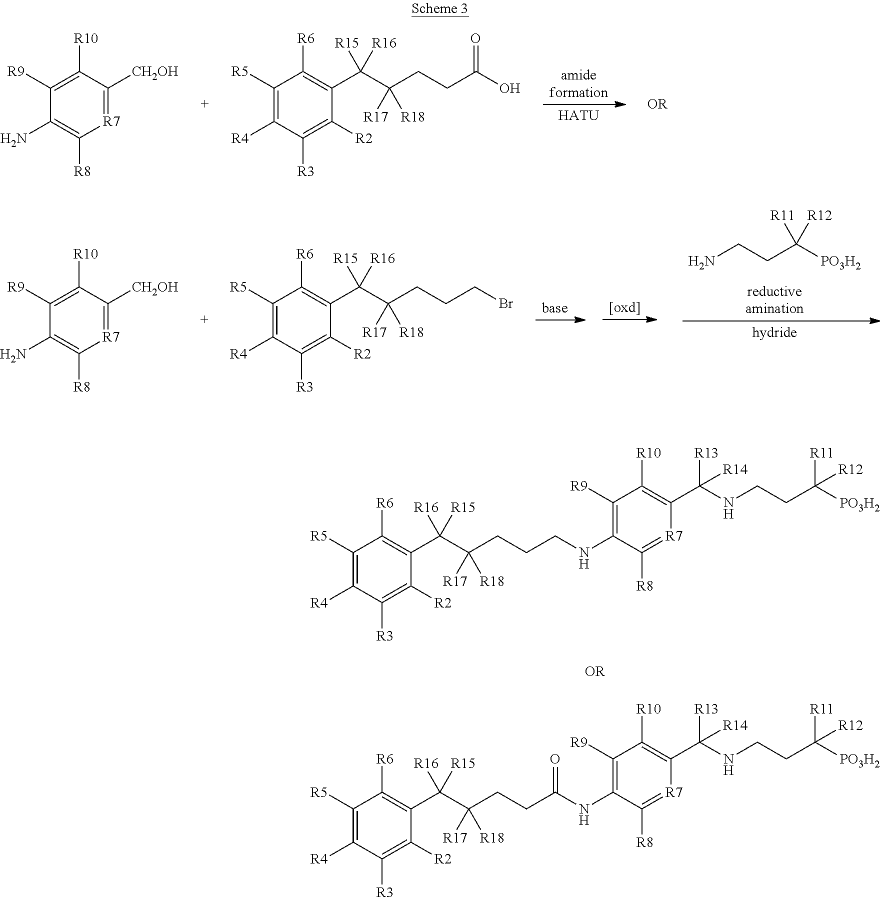

### BRIEF DESCRIPTION OF THE DRAWINGS

FIG. 1 shows the results of Compound 10, (3-{[2,5-difluoro-4-(6-phenylhexyl)benzyl]amino}propyl)phosphonic acid, in the Lymphopenia Assay in Mice.

Lymphopenia was induced by S1P1 agonist, Compound 10, (0.5 mg/kg) in mice (5, 24, 48, 72 hours).

### DETAILED DESCRIPTION OF THE INVENTION

It is to be understood that both the foregoing general description and the following detailed description are exemplary and explanatory only and are not restrictive of the invention claimed. As used herein, the use of the singular includes the plural unless specifically stated otherwise.

It will be readily apparent to those skilled in the art that some of the compounds of the invention may contain one or more asymmetric centers, such that the compounds may exist in enantiomeric as well as in diastereomeric forms. Unless it is specifically noted otherwise, the scope of the present invention includes all enantiomers, diastereomers and racemic mixtures. Some of the compounds of the invention may form salts with pharmaceutically acceptable acids or bases, and such pharmaceutically acceptable salts of the compounds described herein are also within the scope of the invention.

The present invention includes all pharmaceutically acceptable isotopically enriched compounds. Any compound of the invention may contain one or more isotopic atoms enriched or different than the natural ratio such as deuterium ²H (or D) in place of protium ¹H (or H) or use of ¹³C enriched material in place of ¹²C and the like. Similar substitutions can be employed for N, O and S. The use of isotopes may assist in analytical as well as therapeutic aspects of the invention. For example, use of deuterium may increase the in vivo half-life by altering the metabolism (rate) of the compounds of the invention. These compounds can be prepared in accord with the preparations described by use of isotopically enriched reagents.

The following examples are for illustrative purposes only and are not intended, nor should they be construed as limiting the invention in any manner. Those skilled in the art will appreciate that variations and modifications of the following examples can be made without exceeding the spirit or scope of the invention.

As will be evident to those skilled in the art, individual isomeric forms can be obtained by separation of mixtures thereof in conventional manner. For example, in the case of diasteroisomeric isomers, chromatographic separation may be employed.

Compound names were generated with ACDLabs version 8.00 or 12.00 and in some cases Chem Bio Draw Ultra version 12.0; and Intermediates and reagent names used in the examples were generated with software such as ACD version 12.05, Chem Bio Draw Ultra version 12.0.

In general, characterization of the compounds is performed according to the following methods: NMR spectra are recorded on 300 and/or 600 MHz Varian and acquired at room temperature. The spectra of all products were consistent with their structures. Chemical shifts are given in ppm referenced either to internal TMS or to the solvent signal. All the reagents, solvents, catalysts for which the synthesis is not described are purchased from chemical vendors such as Sigma Aldrich, Fluka, Bio-Blocks, Combi-blocks, TCI, VWR, Lancaster, Oakwood, Trans World Chemical, Alfa, AscentScientific LLC., Fisher, Maybridge, Frontier, Matrix, Ukrorgsynth, Toronto, Ryan Scientific, SiliCycle, Anaspec, Syn Chem, Chem-Impex, MIC-scientific, Ltd; however some known intermediates, were prepared according to published procedures.

Usually the compounds of the invention were purified by column chromatography (Auto-column) on a Teledyne-ISCO CombiFlash with a “silica” column generally called a silia-amine column, unless noted otherwise. Compounds of the invention were purified according to either of the following methods below:

Added amino modified silica gel to organic solution (MeOH/CHCl₃) and concentrated. Auto column on a silica gel-amine column with 70% MeOH, 0.5% acetic acid in dichloromethane gave product after removal of solvents, and drying under vacuum.

Product tituration with methanol, filtered, and washed with methanol to give product after removal of solvents, and drying under vacuum.

The following abbreviations are used in the examples:
s, m, h, d second, minute, hour, day
ser. series
brs broad singlet
CH₃CN acetonitrile
psi pound per square inch
CH₂Cl₂ dichloromethane
DMF N,N-dimethylformamide
EtOH ethanol
IPA isopropyl alcohol
Na₂CO₃ sodium carbonate
PdCl₂(PPh₃)₂ bis(triphenylphosphine)palladium(II) chloride
K₂CO₃ potassium carbonate
CuI copper iodide
MnO₂ manganese oxide
MgCl₂ magnesium chloride
NaCl sodium chloride
CHCl₃ chloroform
TBAH tetrabutylammonium hydroxide
NBS N-bromosuccinimide
MeOH methanol
CD₃OD deuterated methanol
CF₃C(O)OD deuterated trifluoroacetic acid
CDCl₃ deuterated chloroform
DMSO-d₆ deuterated dimethyl sulfoxide
HCl hydrochloric acid
Na₂SO₄ sodium sulfate
RT or rt room temperature
MgSO₄ magnesium sulfate
EtOAc ethyl acetate
Auto-column automated flash liquid chromatography
TFA trifluoroacetic acid
THF tetrahydrofuran
M molar
AcOH acetic acid
K₂CO₃ potassium carbonate
D₂O deuterated water
Pd(C) palladium on carbon
PtO₂ platinum oxide
DIBAL diisobutylaluminium hydride
LAH or LiAlH₄ lithium aluminum hydride
DIPEA diisopropyl ethyl amine
HATU 1-[bis(dimethylamino)methylene]-1H-1,2,3-triazolo[4,5-b]pyridinium 3-oxid hexafluorophosphate
TOF MS time of flight mass spectrometry
CAS number reported in brackets, [CAS #]

The following synthetic schemes illustrate how compounds according to the invention can be made. Those skilled in the art will be routinely able to modify and/or adapt the following schemes to synthesize any compound of the invention covered by Formula I.

### Example 1

### Intermediate 1

### Ethyl 3-fluoro-4-(6-phenylhex-1-yn-1-yl)benzoate

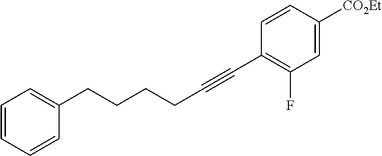 [SMILES: CCOC(=O)c1ccc(C#CCCCCc2ccccc2)c(F)c1]

A mixture of 5-hexyn-1-yl-benzene [100848-88-2], (650 mg, 4.11 mmol), CuI (34 mg), PdCl₂(Ph₃)₂ (120 mg) in triethylamine (5.4 mL), and THF (9 mL) was purged with N₂ for about 5 m. Ethyl 3-fluoro-4-iodobenzoate (1000 mg, 3.40 mmol) was added to the mixture, and the resulting solution was heated at 50° C. for 3 h. The mixture was subjected to an aqueous work-up, and the residue was purified by auto-column (1% ethyl acetate:hexanes) to give ethyl 3-fluoro-4-(6-phenylhex-1-yn-1-yl)benzoate Intermediate 1, 850 mg. (77%).

Intermediates 1-6 were prepared according to the procedure described in Example 1. The starting materials and the results are tabulated below in Table 1.

TABLE 1

| Interm. | IUPAC name | | data |
|---|---|---|---|
| No. | Structure | Starting materials | MS or ¹H NMR δ (ppm) |
| 1 | ethyl 3-fluoro-4-(6-phenylhex-1-yn-1-yl)benzoate 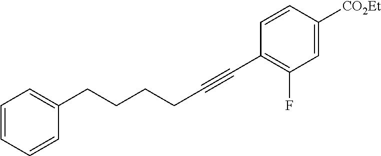 [SMILES: CCOC(=O)c1ccc(C#CCCCCc2ccccc2)c(F)c1] | ethyl 3-fluoro-4- iodobenzoate [1027513-43-4] | ¹H NMR (600 MHz, CDCl₃) δ: 7.74-7.69 (m, 2H), 7.42-7.40 (m, 1H), 7.29-7.26 (m, 2H), 7.20- 7.18 (m, 3H), 4.36 (q, J = 1.2 Hz, 2H), 2.67 (t, J = 7.2 Hz, 2H), 2.49 (t, J = 7.2 Hz, 2H), 1.82-1.78 (m, 2H), 1.69-1.65 (m, 2H), 1.39-1.37 (m, 3H). |
| 2 | methyl 3-methyl-4-(6-phenylhex-1-yn-1-yl)benzoate 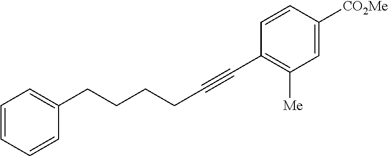 [SMILES: COC(=O)c1ccc(C#CCCCCc2ccccc2)c(C)c1] | methyl 4-iodo-3- methylbenzoate [5471-81-8] | |
| 3 | methyl 4-(6-phenylhex-1-yn-1-yl)-3-(trifluoromethyl)benzoate 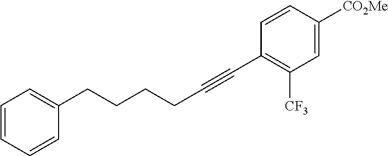 [SMILES: COC(=O)c1ccc(C#CCCCCc2ccccc2)c(C(F)(F)F)c1] | methyl 4-bromo-3- (trifluoromethyl) benzoate [107317-58-8] | |
| 4 | ethyl 3-chloro-4-(6-phenylhex-1-yn-1-yl)benzoate 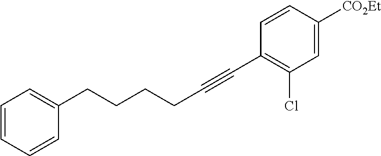 [SMILES: CCOC(=O)c1ccc(C#CCCCCc2ccccc2)c(Cl)c1] | ethyl 3-chloro-4- iodobenzoate [874831-02-4] | |
| 5 | methyl 3-bromo-4-(6-phenylhex-1-yn-1-yl)benzoate 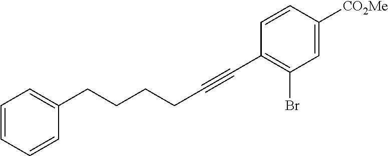 [SMILES: COC(=O)c1ccc(C#CCCCCc2ccccc2)c(Br)c1] | methyl 3-bromo-4- iodobenzoate [249647-24-3] | |
| 6 | 2,5-difluoro-4-(6-phenylhex-1-yn-1-yl)benzaldehyde 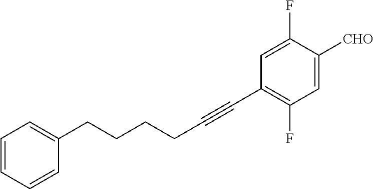 [SMILES: O=Cc1cc(F)c(C#CCCCCc2ccccc2)cc1F] | 4-bromo-2,5- difluorobenzaldehyde [357405-75-5], DIPEA as amine base, 80° C.~18 h. | |

### Example 2

### Intermediate 7

### Ethyl 3-fluoro-4-(6-phenylhexyl)benzoate

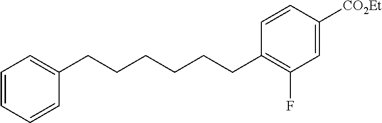 [SMILES: CCOC(=O)c1ccc(CCCCCCc2ccccc2)c(F)c1]

A mixture of ethyl 3-fluoro-4-(6-phenylhex-1-yn-1-yl)benzoate Intermediate 1 (425 mg, 1.31 mmol) Pd/C (10%, 43 mg) H₂ (50 psi) in MeOH (15 mL) was reacted at rt for ˜18 h. (77%). The mixture was filtered and washed through a pad of celite with MeOH. The filtrate was concentrated onto silica gel and auto-column (2% ethyl acetate in hexanes) gave ethyl 3-fluoro-4-(6-phenylhexyl)benzoate Intermediate 7, 320 mg (74%).

Intermediates 7-11 were prepared according to the procedure described in Example 2. The starting materials and the results are tabulated below in Table 2.

TABLE 2

| Interm. | IUPAC name | Starting | data |
|---|---|---|---|
| No. | Structure | materials | MS or ¹H NMR δ (ppm) |
| 7 | ethyl 3-fluoro-4-(6-phenylhexyl)benzoate 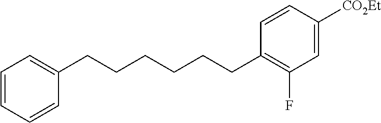 [SMILES: CCOC(=O)c1ccc(CCCCCCc2ccccc2)c(F)c1] | Intermediate 1 | ¹H NMR (600 MHz, CDCl₃) δ: 7.80-7.65 (m, 2H), 7.35- 7.18 (ser. of m, 6H), 4.40 (m, 2H), 2.70-2.55 (ser. of m, 4H), 1.70-1.60 (m, 4H), 1.45-1.35 (m, 7H). |
| 8 | methyl 3-methyl-4-(6-phenylhexyl)benzoate | Intermediate 2 | |
| | 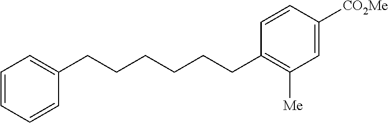 [SMILES: COC(=O)c1ccc(CCCCCCc2ccccc2)c(C)c1] | | |
| 9 | methyl 4-(6-phenylhexyl)-3-(trifluoromethyl)benzoate | Intermediate 3 | |
| | 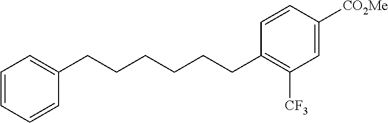 [SMILES: COC(=O)c1ccc(CCCCCCc2ccccc2)c(C(F)(F)F)c1] | | |
| 10 | ethyl 3-chloro-4-(6-phenylhexyl)benzoate 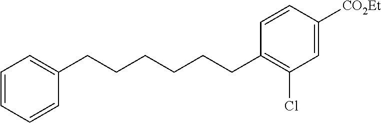 [SMILES: CCOC(=O)c1ccc(CCCCCCc2ccccc2)c(Cl)c1] | Intermediate 4 PtO₂ at 40 psi H₂ THF, ~7 h | |
| 11 | 2,5-difluoro-4-(6-phenylhexyl)benzaldehyde 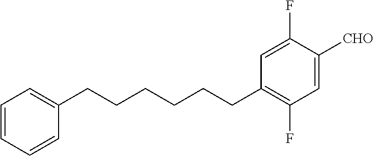 [SMILES: O=Cc1cc(F)c(CCCCCCc2ccccc2)cc1F] | 6 balloon H₂ | |

### Example 3

### Intermediate 12

### (3-Fluoro-4-(6-phenylhex-1-yn-1-yl)phenyl)methanol

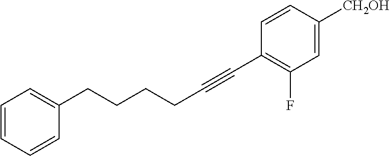 [SMILES: OCc1ccc(C#CCCCCc2ccccc2)c(F)c1]

A mixture of ethyl 3-fluoro-4-(6-phenylhex-1-yn-1-yl)benzoate Intermediate 1 (425 mg, 1.31 mmol) in THF (10 mL) was treated with LiAlH₄ (0.85 mL, 2M in THF) at 0° C., and the reaction was continued at rt for 18 h. Solvents were removed under vacuum and the residue was quenched with crushed ice. 2M HCl (mL) was added and the aqueous layer was extracted (2×) with hexanes:ethyl acetate (1:1, 200 mL total). The combined organic layers were dried over MgSO₄, filtered and concentrated under reduced pressure to give the product as an oil, (3-fluoro-4-(6-phenylhex-1-yn-1-yl)phenyl)methanol Intermediate 12, ˜400 mg (˜99%).

Intermediates 12-18 were prepared according to the procedure described in Example 3. The starting materials and the results are tabulated below in Table 3.

TABLE 3

| Interm. | IUPAC name | Starting | data |
|---|---|---|---|
| No. | Structure | materials | MS or ¹H NMR δ (ppm) |
| 12 | (3-fluoro-4-(6-phenylhex-1-yn-1-yl)phenyl)methanol 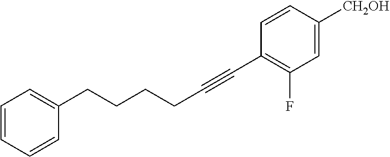 [SMILES: OCc1ccc(C#CCCCCc2ccccc2)c(F)c1] | Intermediate 1 | ¹H NMR (300 MHz, CDCl₃) δ: 7.36-7.03 (ser. of m, 8H), 4.68 (s, 2H), 2.67 (t, J = 7.5 Hz, 2H), 2.48 (t, 6.9 Hz, 2H), 1.82-1.66 (ser. of m, 4H). |
| 13 | (3-methyl-4-(6-phenylhex-1-yn-1-yl)phenyl)methanol | Intermediate 2 | |
| | 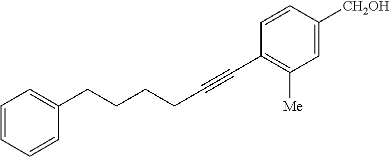 [SMILES: Cc1cc(CO)ccc1C#CCCCCc1ccccc1] | | |
| 14 | (3-bromo-4-(6-phenylhex-1-yn-1-yl)phenyl)methanol 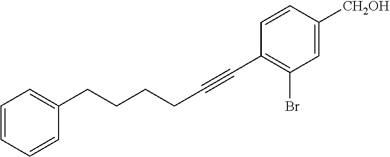 [SMILES: OCc1ccc(C#CCCCCc2ccccc2)c(Br)c1] | Intermediate 5 use of DIBAL (1.5M in toluene) at −40 C | |
| 15 | (3-fluoro-4-(6-phenylhexyl)phenyl)methanol | Intermediate 7 | |
| | 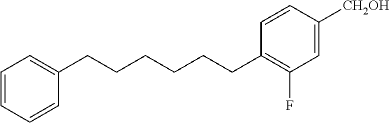 [SMILES: OCc1ccc(CCCCCCc2ccccc2)c(F)c1] | | |
| 16 | (3-methyl-4-(6-phenylhexyl)phenyl)methanol | Intermediate 8 | |
| | 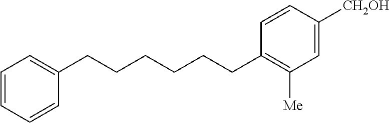 [SMILES: Cc1cc(CO)ccc1CCCCCCc1ccccc1] | | |
| 17 | (4-(6-phenylhexyl)-3-(trifluoromethyl)phenyl)methanol | Intermediate 9 | |
| | 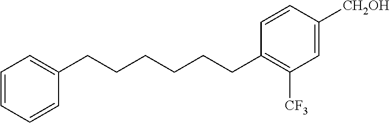 [SMILES: OCc1ccc(CCCCCCc2ccccc2)c(C(F)(F)F)c1] | | |
| 18 | (3-chloro-4-(6-phenylhexyl)phenyl)methanol | Intermediate 10 | |
| | 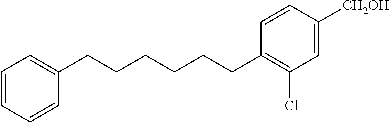 [SMILES: OCc1ccc(CCCCCCc2ccccc2)c(Cl)c1] | | |

### Example 4

### Intermediate 19

### (4-(6-phenylhex-1-yn-1-yl)phenyl)methanol

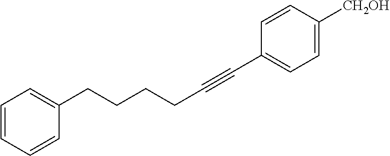 [SMILES: OCc1ccc(C#CCCCCc2ccccc2)cc1]

A solution of (3-bromo-4-(6-phenylhex-1-yn-1-yl)phenyl)methanol Intermediate 14 (1.27 g, 3.7 mmol) in THF (15 mL) at −78° C. was treated with nBuLi (7.4 mL, 2.5 M in hexanes) for ˜5 m. The mixture was quenched with MeOH (3 mL) and warmed to rt. The solvent was removed under vacuum, and the residue was treated with sat. NH₄Cl solution before extraction with ethyl acetate (2×). The combined extracts were dried over MgSO₄, filtered and concentrated under reduced pressure to give (4-(6-phenylhex-1-yn-1-yl)phenyl)methanol Intermediate 19 as an oil.

### Example 5

### Intermediate 20

### N-(2-bromo-4-(hydroxymethyl)phenyl)-5-phenylpentanamide

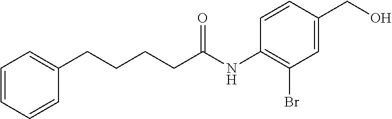 [SMILES: O=C(CCCCc1ccccc1)Nc1ccc(CO)cc1Br]

A mixture of 2-bromo-4-(hydroxymethyl)aniline [146019-46-7] (43 mg, 0.213 mmol), 5-phenylpentanoic acid [2270-20-4] (430 mg, 2.41 mmol), DIPEA (1.3 mL, 7.46 mmol), and HATU (97%, 1.22 g, 3.11 mmol) in DMF (20 mL) was reacted at rt for 18 h. The mixture was subjected to an aqueous work-up, and purified by auto-column (8:2 gradient to 6:4 hexane:ethyl acetate) to give N-(2-bromo-4-(hydroxymethyl)phenyl)-5-phenylpentanamide Intermediate 20, 90 mg. TOF MS m/z (m+Fir 362.08.

### Example 6

### Intermediate 21

### (3-bromo-4-((5-phenylpentyl)amino)phenyl)methanol

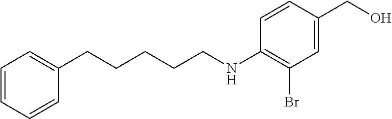 [SMILES: OCc1ccc(NCCCCCc2ccccc2)c(Br)c1]

A mixture of 2-bromo-4-(hydroxymethyl)aniline [146019-46-7] (0.37 g, 1.83 mmol), K₂CO₃ (0.51 g, 3.69 mmol) and (5-bromopentyl)benzene [14469-83-1] (0.33 g, 1.45 mmol) in HMPA (5 mL) was heated to 120° C. for ˜18 h. After an aqueous work-up with hexanes/ethyl acetate, and auto-column (on silica gel) (8.5 hexanes/1.5 ethyl acetate) the crude material, (3-bromo-4-((5-phenylpentyl)amino)phenyl)methanol Intermediate 21 was obtained 0.25 g (approx 50%). TOF MS m/z (M+Na)⁺ 370.20; (M+H)⁻ 348.10

### Example 7

### Intermediate 22

### 3-fluoro-4-(6-phenylhex-1-yn-1-yl)benzaldehyde

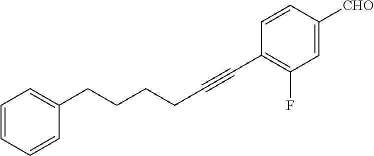 [SMILES: O=Cc1ccc(C#CCCCCc2ccccc2)c(F)c1]

A mixture of (3-fluoro-4-(6-phenylhex-1-yn-1-yl)phenyl)methanol Intermediate 12 (1.31 mmol), MnO₂ (85%, 840 mg, 8.21 mmol) in dioxane (10 mL) was heated to 100° C. for ˜18 h. The mixture was cooled, and filtered through a bed of celite with ethyl acetate. The filtrate was concentrated under vacuum to give an oil residue, 3-fluoro-4-(6-phenylhex-1-yn-1-yl)benzaldehyde Intermediate 22, 290 mg, (˜80% two steps).

Intermediates 22-31 were prepared according to the procedure described in Example 7. The starting materials and the results are tabulated below in Table 4.

TABLE 4

| | | Starting | |
|---|---|---|---|
| Interm. | IUPAC name | materials | data |
| No. | Structure | (Intermediate) | MS or ¹H NMR δ (ppm) |
| 22 | 3-fluoro-4-(6-phenylhex-1-yn-1-yl)benzaldehyde 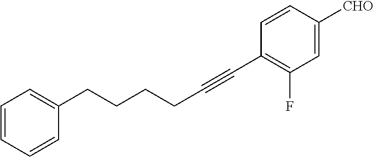 [SMILES: O=Cc1ccc(C#CCCCCc2ccccc2)c(F)c1] | Intermediate 12 | ¹H NMR (300 MHz, CDCl₃) δ: 9.95 (s, 1H), 7.60-7.19 (ser of m, 8H), 2.68 (t, J = 7.8 Hz, 2H), 2.52 (t, J = 6.9 Hz, 2H), 1.85-1.65 (ser of m, 4H). |
| 23 | 3-methyl-4-(6-phenylhex-1-yn-1-yl)benzaldehyde | Intermediate 13 | |
| | 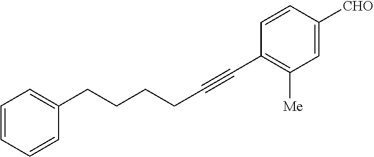 [SMILES: Cc1cc(C=O)ccc1C#CCCCCc1ccccc1] | | |
| 24 | 4-(6-phenylhex-1-yn-1-yl)benzaldehyde | Intermediate 19 | |
| | 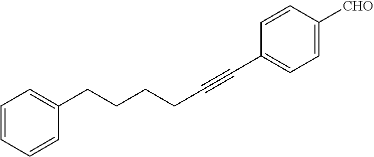 [SMILES: O=Cc1ccc(C#CCCCCc2ccccc2)cc1] | | |
| 25 | 3-bromo-4-(6-phenylhex-1-yn-1-yl)benzaldehyde | Intermediate 14 | |
| | 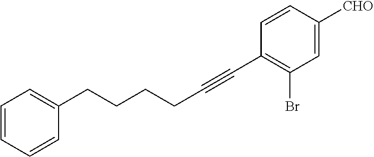 [SMILES: O=Cc1ccc(C#CCCCCc2ccccc2)c(Br)c1] | | |
| 26 | 3-fluoro-4-(6-phenylhexyl)benzaldehyde | Intermediate 15 | |
| | 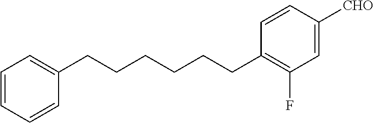 [SMILES: O=Cc1ccc(CCCCCCc2ccccc2)c(F)c1] | | |
| 27 | 3-methyl-4-(6-phenylhexyl)benzaldehyde | Intermediate 16 | |
| | 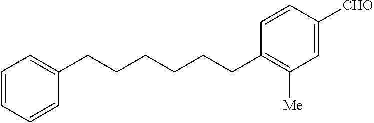 [SMILES: Cc1cc(C=O)ccc1CCCCCCc1ccccc1] | | |
| 28 | 4-(6-phenylhexyl)-3-(trifluoromethyl)benzaldehyde | Intermediate 17 | |
| | 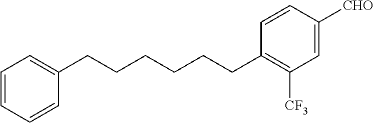 [SMILES: O=Cc1ccc(CCCCCCc2ccccc2)c(C(F)(F)F)c1] | | |
| 29 | 3-chloro-4-(6-phenylhexyl)benzaldehyde | Intermediate 18 | |
| | 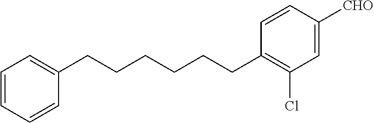 [SMILES: O=Cc1ccc(CCCCCCc2ccccc2)c(Cl)c1] | | |
| 30 | N-(2-bromo-4-formylphenyl)-5-phenylpentanamide | Intermediate 20 | |
| | 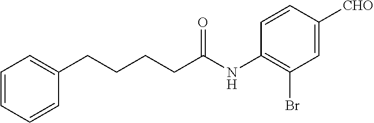 [SMILES: O=Cc1ccc(NC(=O)CCCCc2ccccc2)c(Br)c1] | | |
| 31 | 3-bromo-4-((5-phenylpentyl)amino)benzaldehyde 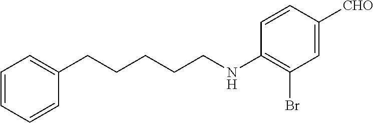 [SMILES: O=Cc1ccc(NCCCCCc2ccccc2)c(Br)c1] | Intermediate 21 | TOF MS m/z (M + H)⁻ 346.2314 |

### Example 8

### Compound 1

### (3-{[3-fluoro-4-(6-phenylhex-1-yn-1-yl)benzyl]amino}propyl)phosphonic acid

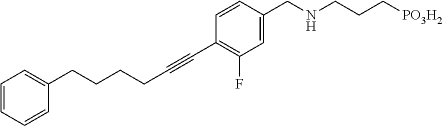

A mixture of 3-fluoro-4-(6-phenylhex-1-yn-1-yl)benzaldehyde Intermediate 22 (290 mg, 1.03 mmol), (3-aminopropyl)phosphonic acid [13138-33-5] (170 mg, 1.22 mmol), and tetrabutyl ammonium hydroxide (3.1 mL of 1.0 M in methanol) in THF (4 mL) and methanol (6 mL) were heated at 60° C. for 30 m followed by 30 m at rt. Sodium borohydride (60 mg, 1.59 mmol) was added, and the mixture was reacted for ˜18 h at rt. The solvent was removed under vacuum. Water was added followed by 2 M HCl to pH ˜3. The mixture was extracted (2×) with 3:1 chloroform:isopropanol (200 mL total). The organic layers were concentrated onto silia-amine silica gel (ISCO). The material was purified by auto-column (silia-amine column, 70% MeOH, 0.5% AcOH in CH₂Cl₂) to give (3-{[3-fluoro-4-(6-phenylhex-1-yn-1-yl)benzyl]amino}propyl)phosphonic acid Compound 1, 324 mg (73%).

Compounds 1 through 12 were prepared according to the procedure described in Example 8 from the corresponding intermediate. The starting materials and the results are tabulated below in Table 5.

TABLE 5

| Comp. | | | |
|---|---|---|---|
| No. | IUPAC name | Interm. No. | ¹H NMR δ (ppm) |
| 1 | (3-{[3-fluoro-4-(6-phenylhex-1-yn-1-yl)benzyl]amino}propyl)phosphonic acid 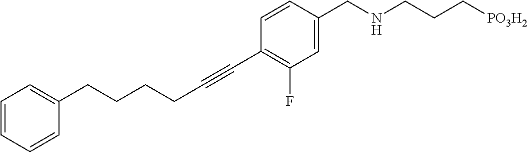 | 22 | (600 MHz, CF₃C(O)OD) δ: 7.45 (t, J = 7.2 Hz, 1H), 7.23 (t, J = 7.8 Hz, 2H), 7.19 (d, J = 7.8 Hz, 2H), 7.13-7.11 (m, 3H), 4.33 (s, 2H), 3.41 (brs, 2H), 2.66 (t, J = 7.8 Hz, 2H), 2.47 (t, J = 7.2 Hz, 2H), 2.30-2.25 (m, 2H), 2.20-2.10 (m, 2H), 1.85- 1.80 (m, 2H), 1.69-1.66 (m, 2H). |
| 2 | (3-{[3-methyl-4-(6-phenylhex-1-yn-1-yl)benzyl]amino}propyl)phosphonic acid 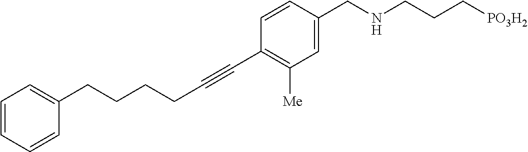 | 23 | (600 MHz, CF₃C(O)OD) δ: 7.37 (d, J = 7.8 Hz, 1H), 7.21-7.19 (m, 2H), 7.16-7.15 (m, 3H), 7.10- 7.06 (m, 2H), 4.24 (s, 2H), 3.37 (s, 2H), 2.64 (t, J = 7.8 Hz, 2H), 2.46 (t, J= 6.6 Hz, 2H), 2.37 (s, 3H), 2.23-2.19 (m, 2H), 2.12-2.09 (m, 2H), 1.82- 1.79 (m, 2H), 1.66-1.64 (m, 2H). |
| 3 | (3-{[4-(6-phenylhex-1-yn-1-yl)benzyl]amino}propyl)phosphonic acid 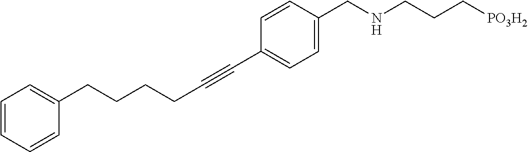 | 24 | (600 MHz, CF₃C(O)OD) δ: 7.44 (dd, J =1.8, 8.4 Hz, 2H), 7.29 (dd, J = 2.4, 8.4 Hz, 2H), 7.24- 7.21 (m, 2H), 7.19-7.18 (m, 2H), 7.13-7.11 (m, 1H), 4.32 (s, 2H), 3.40 (brs, 2H), 2.67-2.64 (m, 2H), 2.44-2.42 (m, 2H), 2.28-2.22 (m, 2H), 2.16- 2.22 (m, 2H), 1.82-1.80 (m, 2H), 1.67-1.64 (m, 2H). |
| 4 | (3-{[3-bromo-4-(6-phenylhex-1-yn-1-yl)benzyl]amino}propyl)phosphonic acid 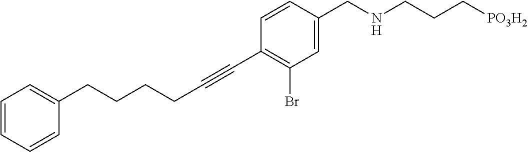 | 25 | (600 MHz, CF₃C(O)OD) δ: 7.60 (s, 1H), 7.45 (d, J = 8.4 Hz, 1H), 7.26-7.21 (m, 3H), 7.18 (d, J = 7.2 Hz, 2H), 7.11 (t, J = 6.6 Hz, 1H), 4.29 (brs, 2H), 3.40 (brs, 2H), 2.66 (t, J = 7.8 Hz, 2H), 2.48 (t, J = 6.6 Hz, 2H), 2.28-2.21 (m, 2H), 2.15-2.11 (m, 2H), 1.89-1.84 (m, 2H), 1.70-1.66 (m, 2H). |
| 5 | (3-{[3-fluoro-4-(6-phenylhexyl)benzyl]amino}propyl)phosphonic acid 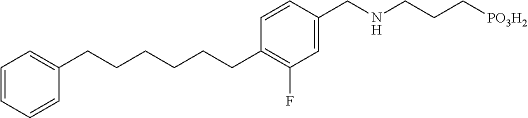 | 26 | (600 MHz, CF₃C(O)OD) δ: 7.30-7.26 (m, 1H), 7.24-7.19 (m, 2H), 7.17- 7.14 (m, 2H), 7.12-7.08 (m. 2H), 7.06-7.02 (m, 1H), 4.30 (t, J = 5.4 Hz, 2H), 3.45-3.37 (m, 2H), 2.67 (t, J = 7.2 Hz, 2H), 2.59 (t, J = 7.8 Hz, 2H), 2.29-2.21 (m, 2H), 2.17- |
| | | | 2.12 (m, 2H), 1.65-1.56 |
| | | | (m, 4H), 1.44-1.35 (m, |
| | | | 4H). |
| 6 | (3-{[3-methyl-4-(6-phenylhexyl)benzyl]amino}propyl)phosphonic acid 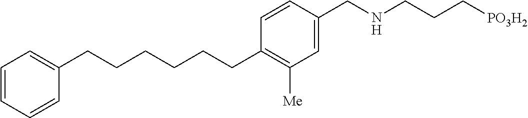 | 27 | (600 MHz, CF₃C(O)OD) δ: 7.21-7.18 (m, 3H), 7.14 (d, J = 7.2 Hz, 2H), 7.10-7.07 (m, 3H), 4.23 (t, J = 5.4 Hz, 2H), 3.40- 3.37 (m, 2H), 2.61 (t, J = 7.8 Hz, 2H), 2.57 (t, J = 7.8 Hz, 2H), 2.28 (s, 3H), 2.25-2.20 (m, 2H), 2.14-2.09 (m, 2H), 1.64- |
| | | | 1.54 (m, 4H), 1.45-1.35 |
| | | | (m, 4H). |
| 7 | (3-{[4-(6-phenylhexyl)-3-(trifluoromethyl)benzyl]amino}propyl)phosphonic acid 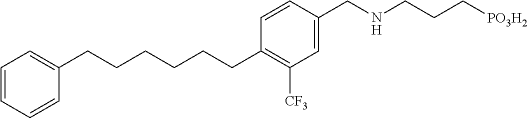 | 28 | (600 MHz, CF₃C(O)OD) δ: 7.65 (s, 1H), 7.51 (d, J = 7.2 Hz, 1H), 7.46 (d, J = 7.2 Hz, 1H), 7.23-7.21 (m, 2H), 7.16 (d, J = 7.2 Hz, 2H), 7.10 (t, J = 6.6 Hz, 1H), 4.37 (s, 2H), 3.44 (s, 2H), 2.83 (t, J = 6.6 Hz, 2H), 2.60 (t, J = 6.6 Hz, 2H), 2.29-2.22 |
| | | | (m, 2H), 2.17-2.13 (m, |
| | | | 2H), 1.70-1.60 (m, 4H), |
| | | | 1.47-1.41 (m, 4H). |
| 8 | (3-{[3-chloro-4-(6-phenylhexyl)benzyl]amino}propyl)phosphonic acid 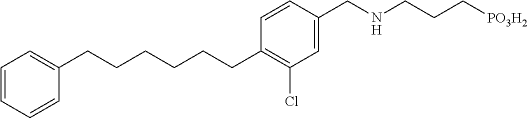 | 29 | (600 MHz, DMSO-d₆ & CF₃C(O)OD) δ: 7.54 (s, 1H), 7.36-7.29 (m, 2H), 7.23-7.18 (m, 2H), 7.13- 7.07 (m, 3H), 4.08 (s, 2H), 3.01 (t, J = 6.6 Hz, 2H), 2.65 (t, J = 7.5 Hz, 2H), 2.54-2.49 (m, 2H), 1.91-1.80 (m, 2H), 1.76- 1.65 (m, 2H), 1.60-1.46 |
| | | | (m, 4H), 1.37-1.25 (m, |
| | | | 4H). |
| 9 | (3-{[4-(6-phenylhexyl)benzyl]amino}propyl)phosphonic acid 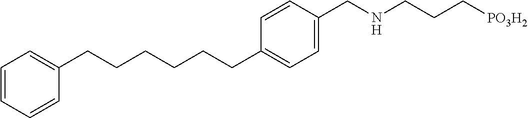 | Compound 3 Note 1 | (600 MHz, CF₃C(O)OD) δ: 7.32-7.10 (ser of m, 9H), 4.30 (t, J =6.0 Hz, 2H), 3.41 (brs, 2H), 2.65 (t, J = 6.6 Hz, 2H), 2.59 (t, J = 7.2 Hz, 2H), 2.28- 2.23 (m, 2H), 2.17-2.12 (m, 2H), 1.68-1.60 (m, 4H), 1.45-1.37 (m, 4H). |
| 10 | (3-{[2,5-difluoro-4-(6-phenylhexyl)benzyl]amino}propyl)phosphonic acid 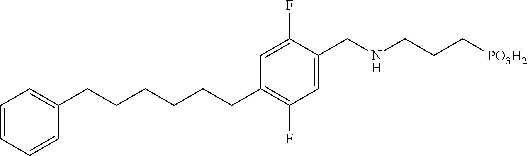 | 11 See Note 2 | (600 MHz, DMSO-d₆ & CF₃C(O)OD) δ: 7.35 (dd, J = 10.2, 6.6 Hz, 1H), 7.23-7.17 (m, 3H), 7.14- 7.10 (m, 3H), 4.13 (s, 2H), 3.04 (t, J = 7.8 Hz, 2H), 2.57 (t, J = 7.8 Hz, 2H), 2.52 (t, J = 7.8 Hz, 2H), 1.88-1.83 (m, 2H), 1.72-1.67 (m, 2H), 1.55- 1.51 (m, 4H), 1.30-1.27 (m, 4H). |
| 11 | [3-({3-bromo-4-[(5-phenylpentanoyl)amino]benzyl}amino)propyl]phosphonic acid 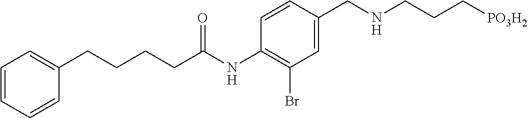 | 30 Note 3 | (600 MHz, CD₃OD and CDCl₃) δ: 7.91 (d, J = 8.4 Hz, 1H), 7.70 (s, 1H), 7.39 (d, J = 8.4 Hz, 1H), 7.23 (t, J = 7.2 Hz, 2H), 7.16-7.12 (m, 3H), 4.00 (s, 2H), 2.99 (t, J = 5.4 Hz, 2H), 2.65 (t, J = 7.2 Hz, 2H), 2.46 (t, J = 5.4 Hz, 2H), 1.95-1.91 |
| | | | (m, 2H), 1.76-1.67 (m, |
| | | | 6H). |
| 12 | [3-({3-bromo-4-[(5-phenylpentyl)amino]benzyl}amino)propyl]phosphonic acid 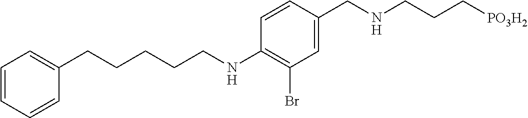 | 31 Note 3 | (600 MHz, CF₃C(O)OD) δ: 7.98 (s, 1H), 7.74 (s, 2H), 7.27 (t, J = 7.2 Hz, 2H), 7.19-7.16 (m, 3H), 4.49 (s, 2H), 3.64 (t, J = 7.2 Hz, 2H), 3.55 (t, J = 6.0 Hz, 2H), 2.68 (t, J = 7.8 Hz, 2H), 2.36-2.31 (m, 2H), 2.22-2.18 (m, 2H), 1.98-1.93 (m, 2H), |
| | | | 1.78-1.73 (m, 2H), 1.57- |
| | | | 1.52 (m, 2H). |

Note 1:
Compound 9 was prepared by a reduction of Compound 3 with H₂ and Pd/C in a method as above-refer to Example 2 above.
Note 2:
A reduction of residual styrene (3-((2,5-difluoro-4-(6-phenylhex-1-en-1-yl)benzyl)amino)propyl)phosphonic acid), <10% (from Example 2) was completed with Pd/C, TBAH, 50 psi H2, ~18 h, and followed by an aqueous work-up and auto-column purification.
Note 3:
Further purification on C-18 column (10% to 100% CH₃CN in water) gave pure material.

Compounds 13 through 65 may be prepared according to analogous procedures described above. The compounds are tabulated below in Table 8.

TABLE 8

| Comp. | Compound name |
|---|---|
| No. | Structure |
| 13 | (3-((2,5-difluoro-4-(6-(4-fluorophenyl)hexyl)benzyl)amino)propyl)phosphonic acid 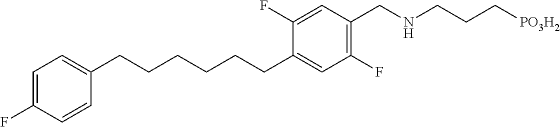 |
| 14 | (3-((3-fluoro-4-(6-(4-fluorophenyl)hexyl)benzyl)amino)propyl)phosphonic acid 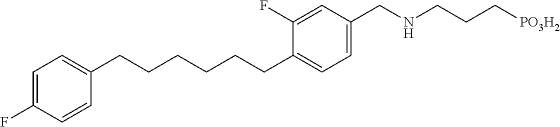 |
| 15 | (3-((2,5-difluoro-4-(6-(3-fluorophenyl)hexyl)benzyl)amino)propyl)phosphonic acid 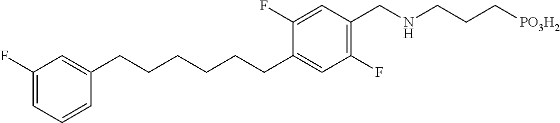 |
| 16 | (3-((2,5-difluoro-4-(6-(2-fluorophenyl)hexyl)benzyl)amino)propyl)phosphonic acid 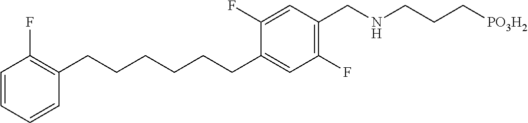 |
| 17 | (3-((2-bromo-5-fluoro-4-(6-phenylhexyl)benzyl)amino)propyl)phosphonic acid 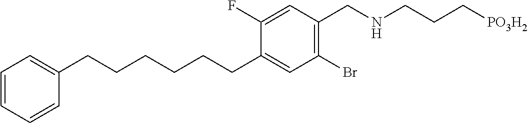 |
| 18 | (3-((5-fluoro-2-methyl-4-(6-phenylhexyl)benzyl)amino)propyl)phosphonic acid 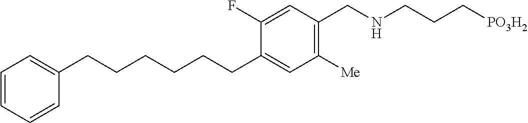 |
| 19 | (3-((5-chloro-2-fluoro-4-(6-phenylhexyl)benzyl)amino)propyl)phosphonic acid 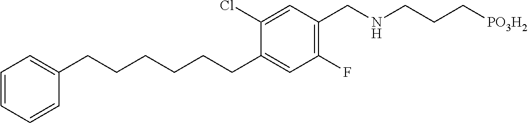 |
| 20 | (3-((5-bromo-2-fluoro-4-(6-phenylhexyl)benzyl)amino)propyl)phosphonic acid 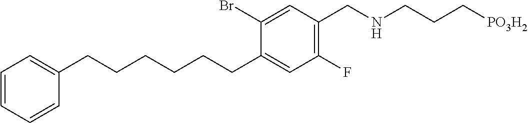 |
| 21 | (3-((2-fluoro-5-methyl-4-(6-phenylhexyl)benzyl)amino)propyl)phosphonic acid 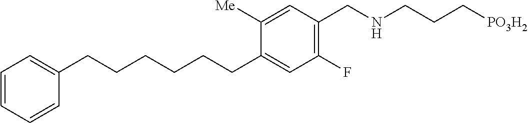 |
| 22 | (3-(((5-(6-phenylhexyl)pyridin-2-yl)methyl)amino)propyl)phosphonic acid 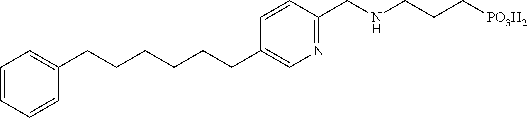 |
| 23 | (3-(((4-fluoro-5-(6-phenylhexyl)pyridin-2-yl)methyl)amino)propyl)phosphonic acid 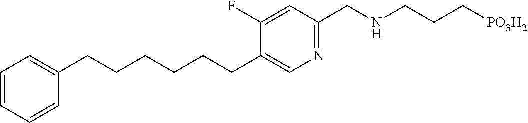 |
| 24 | (3-((2-chloro-5-fluoro-4-(6-(4- fluorophenyl)hexyl)benzyl)amino)propyl)phosphonic acid 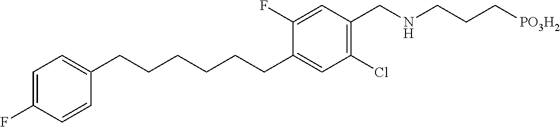 |
| 25 | (3-((2-bromo-5-fluoro-4-(6-(4- fluorophenyl)hexyl)benzyl)amino)propyl)phosphonic acid 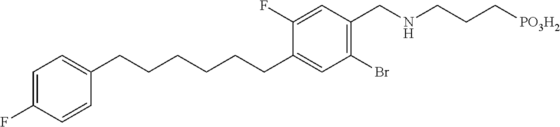 |
| 26 | (3-((5-fluoro-4-(6-(4-fluorophenyl)hexyl)-2- methylbenzyl)amino)propyl)phosphonic acid 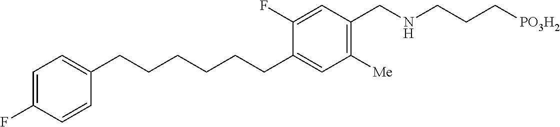 |
| 27 | (3-((5-chloro-2-fluoro-4-(6-(4- fluorophenyl)hexyl)benzyl)amino)propyl)phosphonic acid 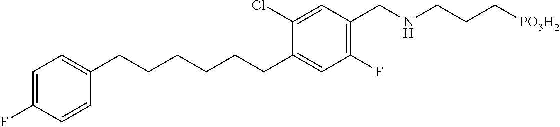 |
| 28 | (3-((5-bromo-2-fluoro-4-(6-(4- fluorophenyl)hexyl)benzyl)amino)propyl)phosphonic acid 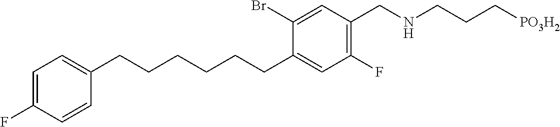 |
| 29 | (3-((2-fluoro-4-(6-(4-fluorophenyl)hexyl)-5- methylbenzyl)amino)propyl)phosphonic acid 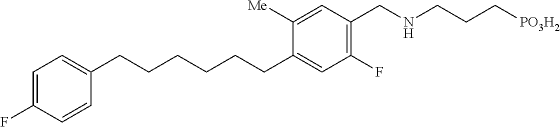 |
| 30 | (3-(((4-fluoro-5-(6-(4-fluorophenyl)hexyl)pyridin-2- yl)methyl)amino)propyl)phosphonic acid 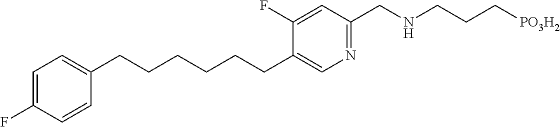 |
| 31 | (3-(((5-(6-(4-fluorophenyl)hexyl)pyridin-2-yl)methyl)amino)propyl)phosphonic acid 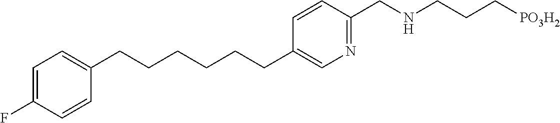 |
| 32 | (3-((4-(5-(1-phenylcyclohexyl)pentyl)benzyl)amino)propyl)phosphonic acid 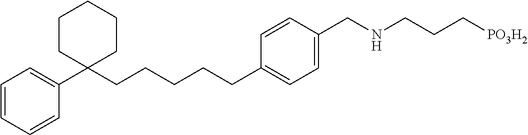 |
| 33 | (3-((4-(6-methyl-6-phenylheptyl)benzyl)amino)propyl)phosphonic acid 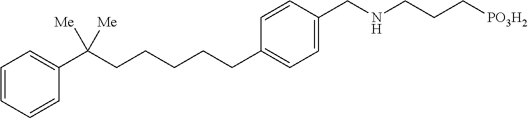 |
| 34 | (3-((4-(5-(1-phenylcyclopentyl)pentyl)benzyl)amino)propyl)phosphonic acid 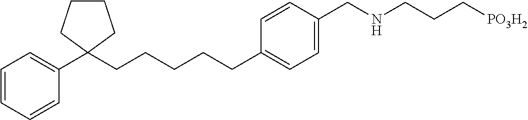 |
| 35 | (3-((4-(5-(3-phenyloxetan-3-yl)pentyl)benzyl)amino)propyl)phosphonic acid 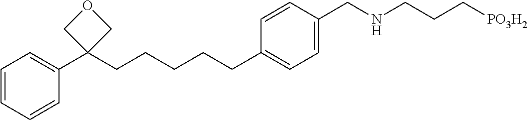 |
| 36 | (3-((2,5-difluoro-4-(5-(1- phenylcyclohexyl)pentyl)benzyl)amino)propyl)phosphonic acid 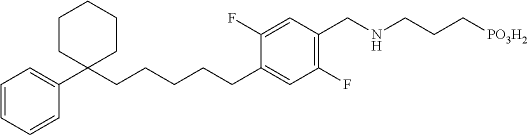 |
| 37 | (3-((3-fluoro-4-(5-(1-phenylcyclohexyl)pentyl)benzyl)amino)propyl)phosphonic acid 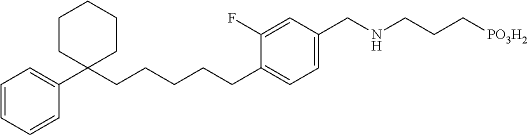 |
| 38 | (3-((2,5-difluoro-4-(6-methyl-6-phenylheptyl)benzyl)amino)propyl)phosphonic acid 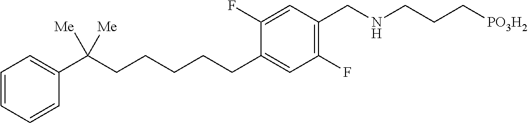 |
| 39 | (3-((2,5-difluoro-4-(5-(1- phenylcyclopentyl)pentyl)benzyl)amino)propyl)phosphonic acid 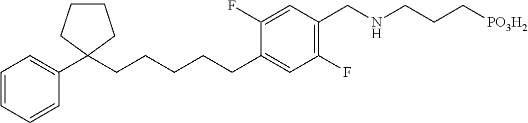 |
| 40 | (3-((2,5-difluoro-4-(5-(3-phenyloxetan-3- yl)pentyl)benzyl)amino)propyl)phosphonic acid 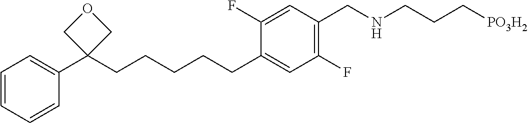 |
| 41 | (3-((4-(5,5-dimethyl-6-phenylhexyl)-3-fluorobenzyl)amino)propyl)phosphonic acid 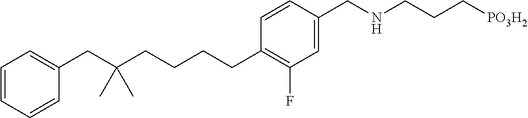 |
| 42 | (3-{[3-fluoro-4-(6-phenylhexyl)benzyl]amino}propyl)phosphonic acid-d₂ 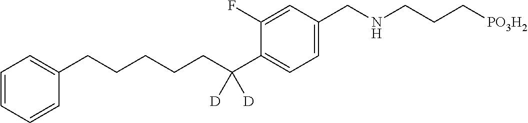 |
| 43 | (3-{[3-chloro-4-(6-phenylhexyl)benzyl]amino}propyl)phosphonic acid-d₂ 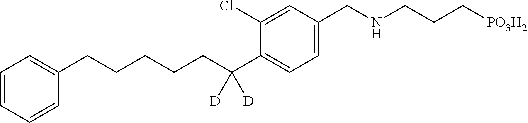 |
| 44 | (3-((3-chloro-2,5-difluoro-4-(6-(4-fluorophenyl)-6- methylheptyl)benzyl)amino)propyl)phosphonic acid 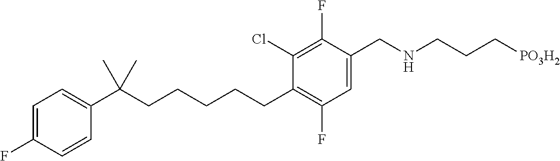 |
| 45 | (3-((3-chloro-4-((5-(4-fluorophenyl)-5- methylhexyl)amino)benzyl)amino)propyl)phosphonic acid 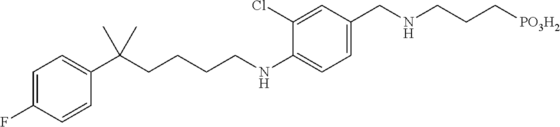 |
| 46 | (3-((3-chloro-4-((4,4-dimethyl-5- phenylpentyl)amino)benzyl)amino)propyl)phosphonic acid 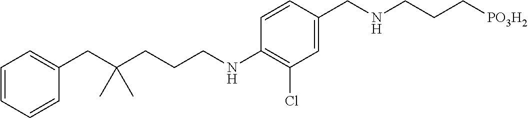 |
| 47 | (3-((3-chloro-4-((4-(3-phenyloxetan-3- yl)butyl)amino)benzyl)amino)propyl)phosphonic acid 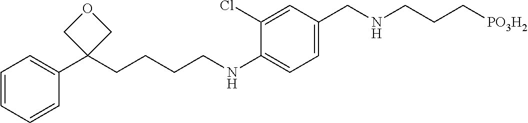 |
| 48 | (3-((3-chloro-4-((4-(1- phenylcyclopentyl)butyl)amino)benzyl)amino)propyl)phosphonic acid 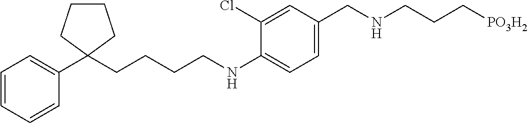 |
| 49 | (3-((3-chloro-4-((4-(1- phenylcyclohexyl)butyl)amino)benzyl)amino)propyl)phosphonic acid 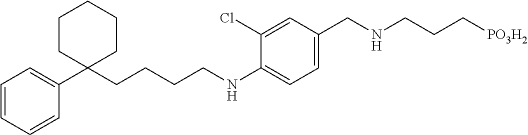 |
| 50 | (3-(((4-chloro-5-((5-phenylpentyl)amino)pyridin-2- yl)methyl)amino)propyl)phosphonic acid 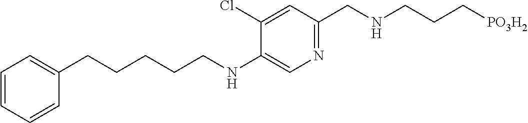 |
| 51 | (3-(((4-chloro-5-((5-(4-fluorophenyl)pentyl)amino)pyridin-2- yl)methyl)amino)propyl)phosphonic acid 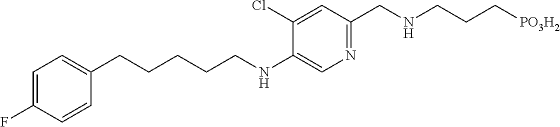 |
| 52 | (3-((5-chloro-2-fluoro-4-((5-(4- fluorophenyl)pentyl)amino)benzyl)amino)propyl)phosphonic acid 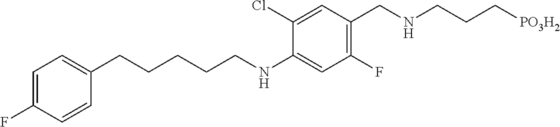 |
| 53 | (3-((3-chloro-4-((5-(4- fluorophenyl)pentyl)amino)benzyl)amino)propyl)phosphonic acid 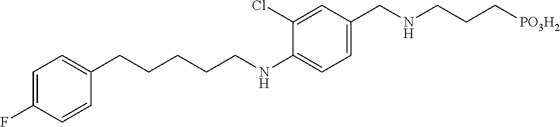 |
| 54 | (3-((3-chloro-4-((5-(3- fluorophenyl)pentyl)amino)benzyl)amino)propyl)phosphonic acid 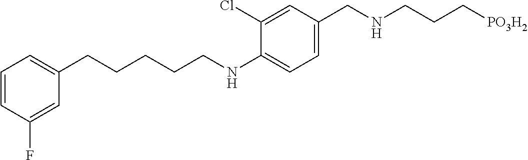 |
| 55 | (3-((3-chloro-4-(6-(4-fluorophenyl)-6- methylheptyl)benzyl)amino)propyl)phosphonic acid 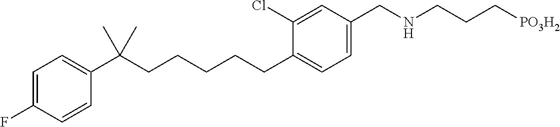 |
| 56 | (3-((3-chloro-4-(5,5-dimethyl-6-phenylhexyl)benzyl)amino)propyl)phosphonic acid 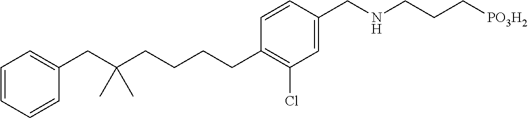 |
| 57 | (3-((3-chloro-4-(5-(3-phenyloxetan-3- yl)pentyl)benzyl)amino)propyl)phosphonic acid 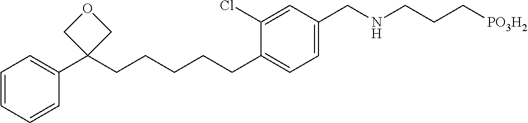 |
| 58 | (3-((3-chloro-4-(5-(1- phenylcyclopentyl)pentyl)benzyl)amino)propyl)phosphonic acid 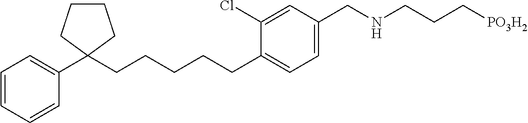 |
| 59 | (3-((3-chloro-4-(5-(1- phenylcyclohexyl)pentyl)benzyl)amino)propyl)phosphonic acid 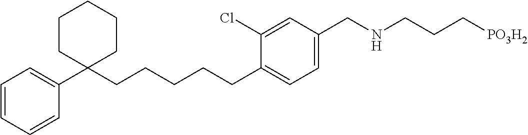 |
| 60 | (3-(((4-chloro-5-(6-phenylhexyl)pyridin-2-yl)methyl)amino)propyl)phosphonic acid 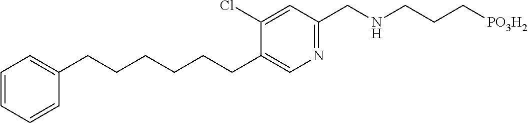 |
| 61 | (3-(((4-chloro-5-(6-(4-fluorophenyl)hexyl)pyridin-2- yl)methyl)amino)propyl)phosphonic acid 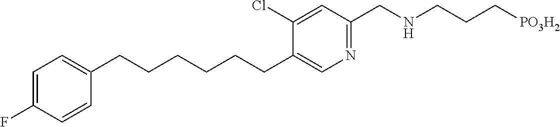 |
| 62 | (3-((5-chloro-2-fluoro-4-(6-(4- fluorophenyl)hexyl)benzyl)amino)propyl)phosphonic acid 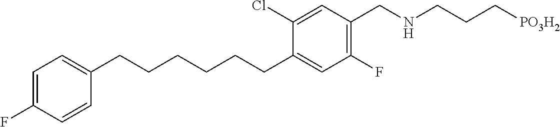 |
| 63 | (3-((3-chloro-4-(6-(4-fluorophenyl)hexyl)benzyl)amino)propyl)phosphonic acid 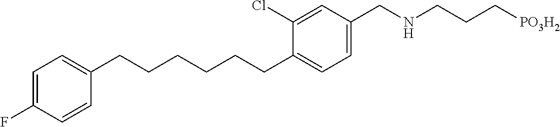 |
| 64 | (3-((3-chloro-4-(6-(3-fluorophenyl)hexyl)benzyl)amino)propyl)phosphonic acid 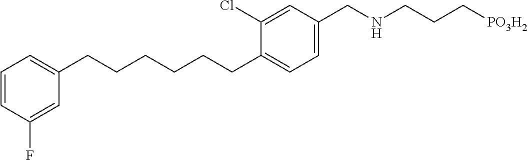 |
| 65 | (3-((3-chloro-4-((5-(2- fluorophenyl)pentyl)amino)benzyl)amino)propyl)phosphonic acid 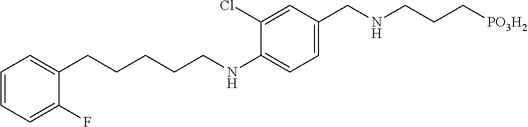 |
| 66 | (3-((4-(6-phenylhexyl)-3-(trifluoromethoxy)benzyl)amino)propyl)phosphonic acid 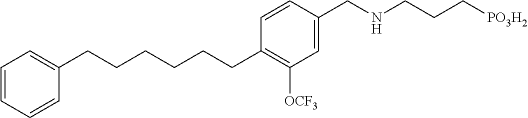 |
| 67 | (3-((4-(6-(p-tolyl)hexyl)-3-(trifluoromethoxy)benzyl)amino)propyl)phosphonic acid 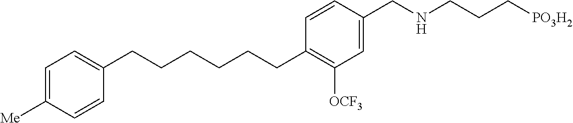 |
| 68 | (3-((4-(5-(1-phenylcyclohexyl)pentyl)-3- (trifluoromethoxy)benzyl)amino)propyl)phosphonic acid 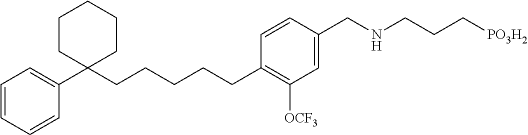 |
| 69 | (3-((3-(perfluoroethyl)-4-(6-phenylhexyl)benzyl)amino)propyl)phosphonic acid 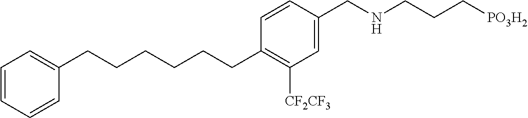 |
| 70 | (3-((3-(perfluoroethyl)-4-(6-(p-tolyl)hexyl)benzyl)amino)propyl)phosphonic acid 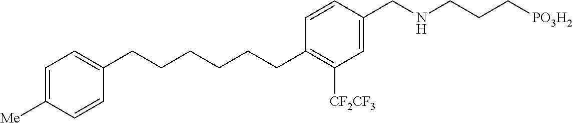 |
| 71 | (3-((3-(perfluoroethyl)-4-(5-(1- phenylcyclohexyl)pentyl)benzyl)amino)propyl)phosphonic acid 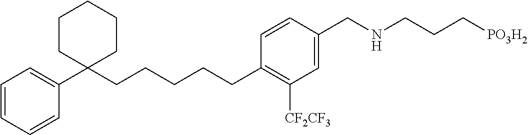 |
| 72 | (3-((4-((5-phenylpentyl)amino)-3- (trifluoromethoxy)benzyl)amino)propyl)phosphonic acid 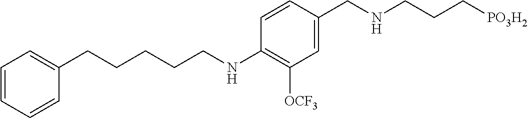 |
| 73 | (3-((4-((5-(p-tolyl)pentyl)amino)-3- (trifluoromethoxy)benzyl)amino)propyl)phosphonic acid 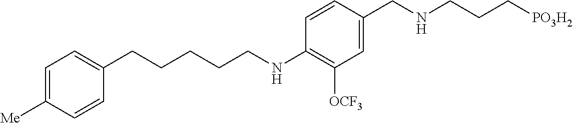 |
| 74 | (3-((4-((4-(1-phenylcyclohexyl)butyl)amino)-3- (trifluoromethoxy)benzyl)amino)propyl)phosphonic acid 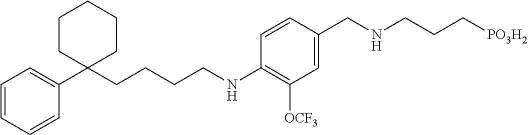 |
| 75 | (3-((3-(perfluoroethyl)-4-((5- phenylpentyl)amino)benzyl)amino)propyl)phosphonic acid 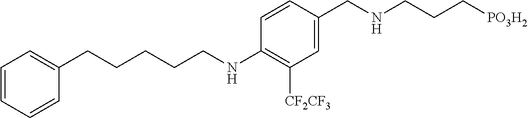 |
| 76 | (3-((3-(perfluoroethyl)-4-((5-(p- tolyl)pentyl)amino)benzyl)amino)propyl)phosphonic acid 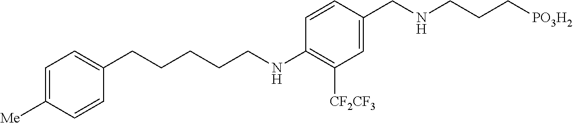 |
| 77 | (3-((3-(perfluoroethyl)-4-((4-(1- phenylcyclohexyl)butyl)amino)benzyl)amino)propyl)phosphonic acid 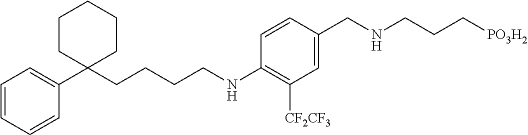 |
| 78 | (3-((4-(6-(4-fluorophenyl)hexyl)-3- (trifluoromethoxy)benzyl)amino)propyl)phosphonic acid 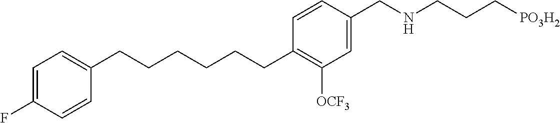 |
| 79 | (3-((4-(6-(4-fluorophenyl)hexyl)-3- (perfluoroethyl)benzyl)amino)propyl)phosphonic acid 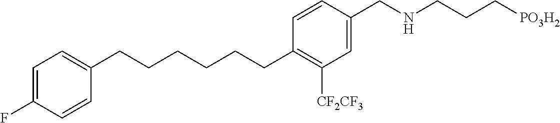 |
| 80 | (3-((4-(5-(1-(4-fluorophenyl)cyclohexyl)pentyl)-3- (trifluoromethoxy)benzyl)amino)propyl)phosphonic acid 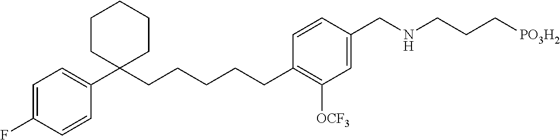 |
| 81 | (3-((4-(5-(1-(4-fluorophenyl)cyclohexyl)pentyl)-3- (perfluoroethyl)benzyl)amino)propyl)phosphonic acid 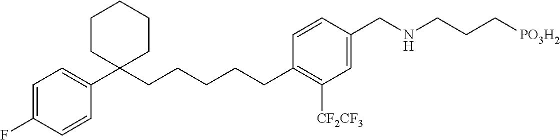 |
| 82 | (3-((4-((5-(4-fluorophenyl)pentyl)amino)-3- (trifluoromethoxy)benzyl)amino)propyl)phosphonic acid 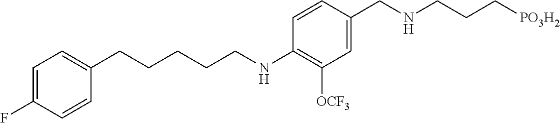 |
| 83 | (3-((4-((5-(4-fluorophenyl)pentyl)amino)-3- (perfluoroethyl)benzyl)amino)propyl)phosphonic acid 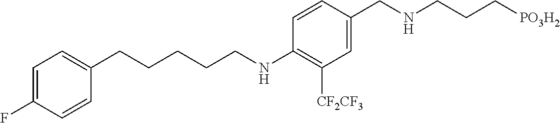 |
| 84 | (3-((4-((4-(1-(4-fluorophenyl)cyclohexyl)butyl)amino)-3- (trifluoromethoxy)benzyl)amino)propyl)phosphonic acid 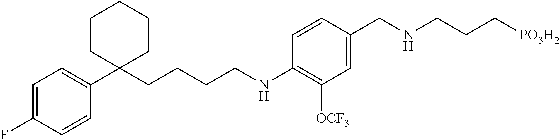 |
| 85 | (3-((4-((4-(1-(4-fluorophenyl)cyclohexyl)butyl)amino)-3- (perfluoroethyl)benzyl)amino)propyl)phosphonic acid 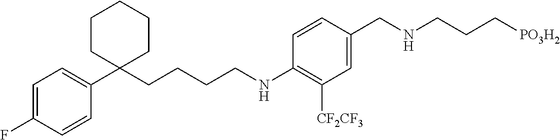 |
| 86 | (3-((4-(6-(4-fluorophenyl)hexyl)-3- (trifluoromethyl)benzyl)amino)propyl)phosphonic acid 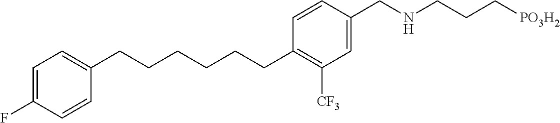 |
| 87 | (3-((4-(6-(p-tolyl)hexyl)-3-(trifluoromethyl)benzyl)amino)propyl)phosphonic acid 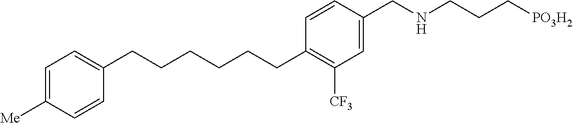 |
| 88 | (3-((4-(5-(1-phenylcyclohexyl)pentyl)-3- (trifluoromethyl)benzyl)amino)propyl)phosphonic acid 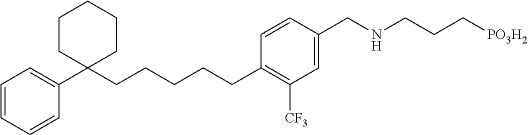 |
| 89 | (3-((4-(5-(1-(4-fluorophenyl)cyclohexyl)pentyl)-3- (trifluoromethyl)benzyl)amino)propyl)phosphonic acid 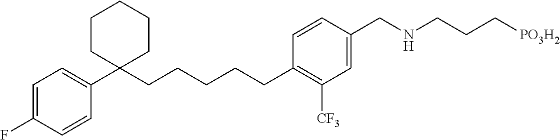 |
| 90 | (3-((4-((5-phenylpentyl)amino)-3- (trifluoromethyl)benzyl)amino)propyl)phosphonic acid 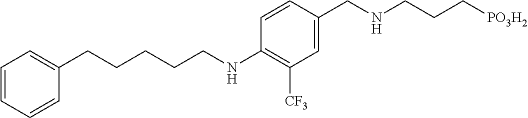 |
| 91 | (3-((4-((5-(4-fluorophenyl)pentyl)amino)-3- (trifluoromethyl)benzyl)amino)propyl)phosphonic acid 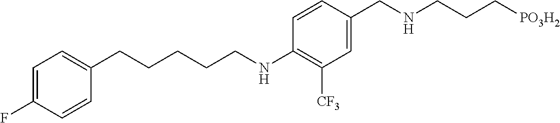 |
| 92 | (3-((4-((5-(p-tolyl)pentyl)amino)-3- (trifluoromethyl)benzyl)amino)propyl)phosphonic acid 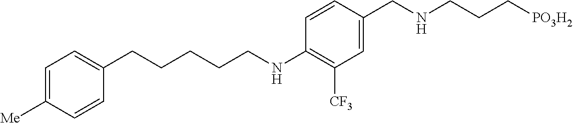 |
| 93 | (3-((4-((4-(1-phenylcyclohexyl)butyl)amino)-3- (trifluoromethyl)benzyl)amino)propyl)phosphonic acid 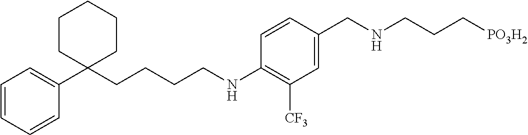 |
| 94 | (3-((4-((4-(1-(4-fluorophenyl)cyclohexyl)butyl)amino)-3- (trifluoromethyl)benzyl)amino)propyl)phosphonic acid 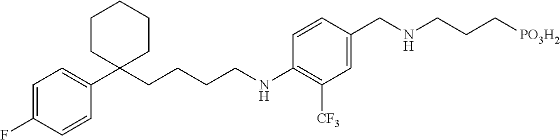 |

### Biological Examples

### In Vitro Assay

Compounds were tested for S1P1 activity using the GTP γ³⁵S binding assay. These compounds may be assessed for their ability to activate or block activation of the human S1P1 receptor in cells stably expressing the S1P1 receptor.

GTP γ³⁵S binding was measured in the medium containing (mM) HEPES 25, pH 7.4, MgCl₂ 10, NaCl 100, dithitothreitol 0.5, digitonin 0.003%, 0.2 nM GTP γ³⁵S, and 5 μg membrane protein in a volume of 150 μl. Test compounds were included in the concentration range from 0.08 to 5,000 nM unless indicated otherwise. Membranes were incubated with 100 μM 5′-adenylylimmidodiphosphate for 30 min, and subsequently with 10 μM GDP for 10 min on ice. Drug solutions and membrane were mixed, and then reactions were initiated by adding GTP γ³⁵S and continued for 30 min at 25° C. Reaction mixtures were filtered over Whatman GF/B filters under vacuum, and washed three times with 3 mL of ice-cold buffer (HEPES 25, pH7.4, MgCl₂ 10 and NaCl 100). Filters were dried and mixed with scintillant, and counted for ³⁵S activity using a β-counter. Agonist-induced GTP γ³⁵S binding was obtained by subtracting that in the absence of agonist. Binding data were analyzed using a non-linear regression method. In case of antagonist assay, the reaction mixture contained 10 nM S1P in the presence of test antagonist at concentrations ranging from 0.08 to 5000 nM.

TABLE 9
Activity potency: S1P1 receptor from GTP γ³⁵S: nM, (EC₅₀)

| | | S1P1 |
|---|---|---|
| Comp | IUPAC name | EC₅₀ |
| No. | Structure | (nM) |
| 1 | (3-{[3-fluoro-4-(6-phenylhex-1-yn-1-yl)benzyl]amino}propyl)phosphonic acid 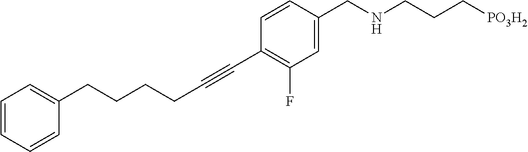 | 4.3 |
| 2 | (3-{[3-methyl-4-(6-phenylhex-1-yn-1-yl)benzyl]amino}propyl)phosphonic acid 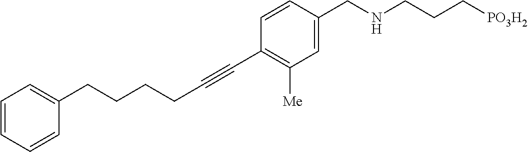 | 3.4 |
| 3 | (3-{[4-(6-phenylhex-1-yn-1-yl)benzyl]amino}propyl)phosphonic acid 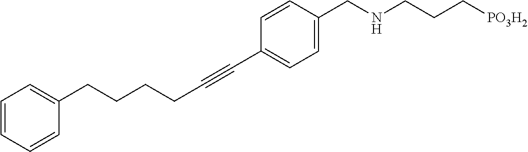 | 26.7 |
| 4 | (3-{[3-bromo-4-(6-phenylhex-1-yn-1-yl)benzyl]amino}propyl)phosphonic acid 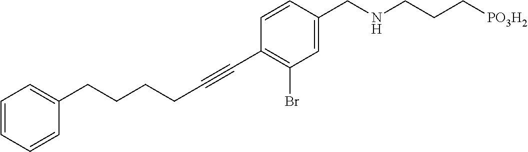 | 22.1 |
| 5 | (3-{[3-fluoro-4-(6-phenylhexyl)benzyl]amino}propyl)phosphonic acid 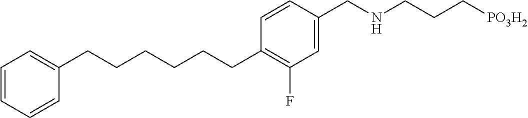 | 4.2 |
| 6 | (3-{[3-methyl-4-(6-phenylhexyl)benzyl]amino}propyl)phosphonic acid 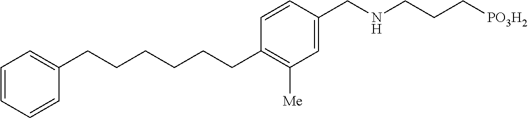 | 0.7 |
| 7 | (3-{[4-(6-phenylhexyl)-3-(trifluoromethyl)benzyl]amino}propyl)phosphonic acid 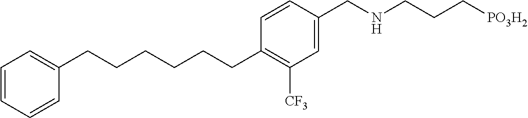 | 11.2 |
| 8 | (3-{[3-chloro-4-(6-phenylhexyl)benzyl]amino}propyl)phosphonic acid 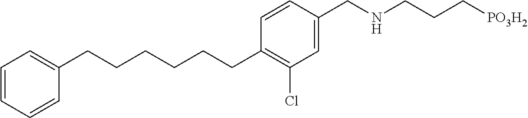 | 0.5 |
| 9 | (3-{[4-(6-phenylhexyl)benzyl]amino}propyl)phosphonic acid 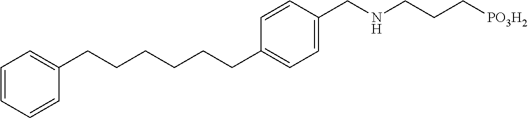 | 6.8 |
| 10 | (3-{[2,5-difluoro-4-(6-phenylhexyl)benzyl]amino}propyl)phosphonic acid 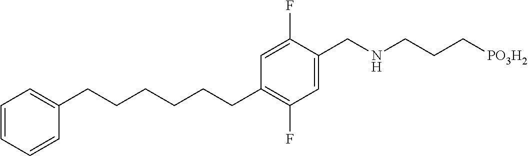 | 1.9 |
| 11 | [3-({3-bromo-4-[(5-phenylpentanoyl)amino]benzyl}amino)propyl]phosphonic acid 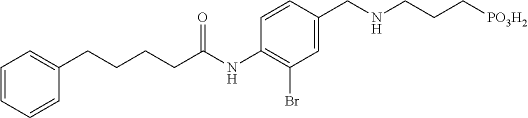 | 104.8 |
| 12 | [3-({3-bromo-4-[(5-phenylpentyl)amino]benzyl}amino)propyl]phosphonic acid 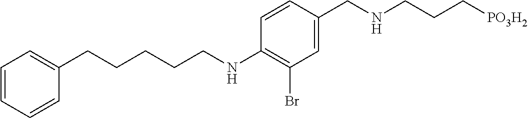 | 4.1 |

### In Vivo Assay

### Lymphopenia Assay in Mice

Test drugs are prepared in a solution containing 3% (w/v) 2-hydroxy propyl β-cyclodextrin (HPBCD) and 1% DMSO to a final concentration of 1 mg/ml, and subcutaneously injected to female C57BL6 mice (CHARLES RIVERS) weighing 20-25 g at the dose of 0.5 to 10 mg/Kg. Blood samples are obtained by puncturing the submandibular skin with a Goldenrod animal lancet at 5, 24, 48, and 72 hrs post drug application. Blood is collected into microvettes (SARSTEDT) containing EDTA tripotassium salt. Lymphocytes in blood samples are counted using a HEMAVET Multispecies Hematology System, HEMAVET HV950FS (Drew Scientific Inc.).
(Hale, J. et al Bioorg.& Med. Chem. Lett. 14 (2004) 3351).

### DETAILED DESCRIPTION

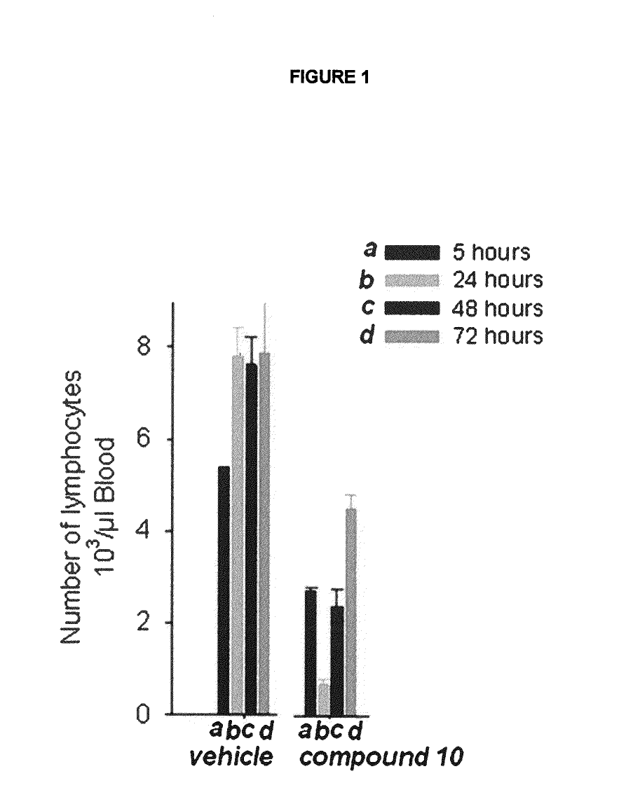

A lymphopenia assay in mice; as previously described, was employed to measure the in vivo blood lymphocyte depletion after dosing with the test compound (3-{[2,5-difluoro-4-(6-phenylhexyl)benzyl]amino}propyl)phosphonic acid Compound-10. This S1P1 modulator, (3-{[2,5-difluoro-4-(6-phenylhexyl)benzyl]amino}propyl)phosphonic acid Compound-10 is useful for S1P-related diseases and exemplified by the lymphopenia in vivo response. Test compound, was prepared in a solution containing 3% (w/v) 2-hydroxy propyl β-cyclodextrin (HPBCD) and 1% DMSO to a final concentration of 1 mg/ml, and subcutaneously injected to female C57BL6 mice (CHARLES RIVERS) weighing 20-25 g at the dose of 0.5 mg/Kg. Blood samples were obtained by puncturing the submandibular skin with a Goldenrod animal lancet at different time intervals such as: 5, 24, 48, 72 h post drug application. Blood was collected into microvettes (SARSTEDT) containing EDTA tripotassium salt. Lymphocytes in blood samples were counted using a HEMAVET Multispecies Hematology System, HEMAVET HV950FS (Drew Scientific Inc.). Results are shown in the FIG. 1 that depicts lowered lymphocyte count after 5 hours (<1 number of lymphocytes 10³/μL blood).

What is claimed is:

1. A compound represented by Formula I, its enantiomers, diastereoisomers, tautomers, or a pharmaceutically acceptable salt thereof 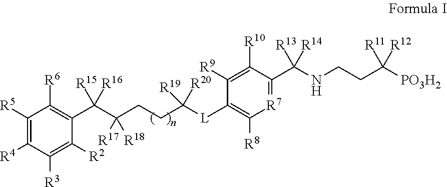
wherein:
n is 0 or 1;
L is —NR—, —C(O)NR¹—, —CR²³R²⁴— or —C≡C—;
R is H, or C₁₋₃ alkyl;
R¹ is H or C₁₋₃ alkyl;
R² is H, D, F, Cl, Br, C₁₋₄ alkyl, C₂₋₄ alkenyl, C₂₋₄ alkynyl, OH, NH₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;
R³ is H, D, F, Cl, Br, C₁₋₄ alkyl, C₂₋₄ alkenyl, C₂₋₄ alkynyl, OH, NH₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;
R⁴ is H, D, F, Cl, Br, C₁₋₄ alkyl, C₂₋₄ alkenyl, C₂₋₄ alkynyl, OH, NH₂, C₁₋₄perfluoroalkyl, O(C₁₋₄perfluoroalkyl, OCF₂H, OCF₂CF₂H, O(C₁₋₄ alkyl), CN, SO₂R²¹ or C(O)R²²;
R⁵ is H, D, F, Cl, Br, C₁₋₄ alkyl, C₂₋₄ alkenyl, C₂₋₄ alkynyl; OH, NH₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²²;
R⁶ is H, D, F, Cl, Br, C₁₋₄ alkyl, C₂₋₄ alkenyl, C₂₋₄ alkynyl, OH, NH₂, C₁₋4perfluoroalkyl, O(C₁₋₄)perfluoroalkyl, OCF₂H, OCF₂CF₂H, O(C₁₋₄ alkyl), ON, SO₂R²¹ or C(O)R²²;
R⁷ is N or CR^{7a};
R^{7a} is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), ON, SO₂R²¹ or C(O)R²²;
R⁸ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), ON, SO₂R²¹ or C(O)R²²;
R⁹ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), ON, SO₂R²¹ or C(O)R²²;
R¹⁰ is H, D, F, Cl, Br, C₁₋₄ alkyl, C₂₋₄ alkenyl, C₂₋₄ alkynyl, OH, NH₂, NO₂, C₁₋₄perfluoroalkyl, O(C₁₋₄)perfluoroalkyl, OCF₂H, OCF₂CF₂H, O(C₁₋₄ alkyl), CN, SO₂R²¹ or C(O)R²¹;
R¹¹ is H, D, F or C₁₋₄ alkyl;
R¹² is H, D, F or C₁₋₄ alkyl;
R¹³ is H, D, F, C₁₋₄ alkyl, C₁₋₄perfluoroalkyl, or together with R¹⁴ can form a 3 to 6 membered ring cycloalkyl or heterocycle;
R¹⁴ is H, D, F, C₁₋₄ alkyl, C₁₋₄perfluoroalkyl, or together with R¹³ can form a 3 to 6 membered ring cycloalkyl or heterocycle;
R¹⁵ is H, D, F, C₁₋₄ alkyl or C₁₋₄perfluoroalkyl or together with R¹⁶ can form a 3 to 6 membered ring cycloalkyl or heterocycle;
R¹⁶ is H, D, F, C₁₋₄ alkyl or C₁₋₄perfluoroalkyl or together with R¹⁵ can form a 3 to 6 membered ring cycloalkyl or heterocycle;
R¹⁷ is H, D, F, C₁₋₄ alkyl, C₁₋₄perfluoroalkyl, or together with R¹⁸ can form a 3 to 6 membered ring cycloalkyl or heterocycle;
R¹⁸ is H, D, F, C₁₋₄ alkyl, C₁₋₄perfluoroalkyl, or together with R¹⁷ can form a 3 to 6 membered ring cycloalkyl or heterocycle;
R¹⁹ is H, D, F, C₁₋₄ alkyl, C₁₋₄perfluoroalkyl;
R²⁰ is H, D, F, C₁₋₄ alkyl, C₁₋₄perfluoroalkyl;
R²¹ is H, C₁₋₄ alkyl, OH, C₁₋₄perfluoroalkyl or N(R²⁵)₂;
R²² is H, C₁₋₄ alkyl, OH, C₁₋₄perfluoroalkyl or N(R²⁵)₂;
R²³ is H, D, F, C₁₋₄ alkyl, C₁₋₄perfluoroalkyl;
R²⁴ is H, D, F, C₁₋₄ alkyl, C₁₋₄perfluoroalkyl; and
R²⁵ is H or C₁₋₄ alkyl;
with the provisos:
when n is 1 then L is —NR—, or —CR²³R²⁴—;
when n is 0 then L is —C(O)NR¹— or —C≡C—.

2. The compound according to claim 1, wherein:
n is 1;
L is —CR²³R²⁴—; and
R⁷ is N.

3. The compound according to claim 1, wherein:
n is 1;
L is —CR²³R²⁴—;
R² is H;
R³ is H;
R⁴ is H;
R⁵ is H;
R⁶ is H;
R⁷ is CR^{7a};
R^{7a} is H;
R⁹ is H;
R¹⁰ is H;
R¹¹ is H;
R¹² is H;
R¹³ is H;
R¹⁴ is H;
R¹⁵ is H;
R¹⁶ is H;
R¹⁷ is H;
R¹⁸ is H;
R¹⁹ is H;
R²⁰ is H;
R²³ is H; and
R²⁴ is H.

4. The compound according to claim 1, wherein:
n is 1;
L is —NR—;
R is H, methyl, ethyl, n-propyl or isopropyl;
R² is H;
R³ is H;
R⁴ is H;
R⁵ is H;
R⁶ is H;
R⁷ is CR^{7a};
R^{7a} is H;
R⁹ is H;
R¹⁰ is H;
R¹¹ is H;
R¹² is H;
R¹³ is H;
R¹⁴ is H;
R¹⁵ is H;
R¹⁶ is H;
R¹⁷ is H;
R¹⁸ is H;
R¹⁹ is H;
R²⁰ is H;
R²³ is H; and
R²⁴ is H.

5. The compound according to claim 1, wherein:
n is 1;
L is —CR²³R²⁴—;
R² is H;
R³ is H;
R⁴ is H;
R⁵ is H;
R⁶ is H;
R⁷ is CR^{7a};
R^{7a} is H;
R¹¹ is H;
R¹² is H;
R¹³ is H;
R¹⁴ is H;
R¹⁵ is H;
R¹⁶ is H;
R¹⁷ is H;
R¹⁸ is H;
R¹⁹ is H;
R²⁰ is H;
R²³ is H; and
R²⁴ is H.

6. The compound according to claim 1, wherein:
n is 1;
L is —NR—;
R² is H;
R³ is H;
R⁴ is H;
R⁵ is H;
R⁶ is H;
R⁷ is CR^{7a};
R^{7a} is H;
R¹¹ is H;
R¹² is H;
R¹³ is H;
R¹⁴ is H;
R¹⁵ is H;
R¹⁶ is H;
R¹⁷ is H;
R¹⁸ is H;
R¹⁹ is H;
R²⁰ is H;
R²³ is H; and
R²⁴ is H.

7. The compound according to claim 1, wherein:
n is 0;
L is —C(O)NR¹—;
R² is H;
R³ is H;
R⁴ is H;
R⁵ is H;
R⁶ is H;
R⁷ is CR^{7a};
R^{7a} is H;
R¹¹ is H;
R¹² is H;
R¹³ is H;
R¹⁴ is H;
R¹⁵ is H;
R¹⁶ is H;
R¹⁷ is H;
R¹⁸ is H;
R¹⁹ is H;
R²⁰ is H;
R²³ is H; and
R²⁴ is H.

8. The compound according to claim 1, wherein:
n is 1;
L is —CR²³R²⁴—;
R² is H;
R³ is H;
R⁵ is H;
R⁶ is H;
R⁷ is CR^{7a};
R⁸ is H;
R¹⁰ is H;
R¹¹ is H;
R¹² is H;
R¹³ is H;
R¹⁴ is H;
R¹⁵ is H;
R¹⁶ is H;
R¹⁷ is H;
R¹⁸ is H;
R¹⁹ is H;
R²⁰ is H;
R²³ is H or D; and
R²⁴ is H or D.

9. The compound according to claim 1, wherein:
n is 1;
L is —CR²³R²⁴—;
R² is H;
R³ is H;
R⁵ is H;
R⁶ is H;
R⁷ is CR^{7a};
R⁸ is H;
R¹⁰ is H;
R¹¹ is H;
R¹² is H;
R¹³ is H;
R¹⁴ is H;
R¹⁵ is together with R¹⁶ can form a 3 to 6 membered ring cycloalkyl or heterocycle;
R¹⁶ is together with R¹⁵ can form a 3 to 6 membered ring cycloalkyl or heterocycle;
R¹⁷ is H;
R¹⁸ is H;
R¹⁹ is H;
R²⁰ is H;
R²³ is H; and
R²⁴ is H.

10. The compound according to claim 1, wherein:
n is 1;
L is —CR²³R²⁴—.
R² is H;
R³ is H;
R⁵ is H;
R⁶ is H;
R⁷ is CR^{7a};
R⁸ is H;
R¹⁰ is H;
R¹¹ is H;
R¹² is H;
R¹³ is H;
R¹⁴ is H;
R¹⁵ is together with R¹⁶ can form a 3 to 6 membered ring heterocycle;
R¹⁶ is together with R¹⁵ can form a 3 to 6 membered ring heterocycle;
R¹⁷ is H;
R¹⁸ is H;
R¹⁹ is H;
R²⁰ is H;
R²³ is H; and
R²⁴ is H.

11. The compound according to claim 1, wherein:
n is 1;
L is —CR²³R²⁴—;
R² is H;
R³ is H;
R⁵ is H;
R⁶ is H;
R⁷ is CR^{7a};
R⁸ is H;
R¹⁰ is H;
R¹¹ is H;
R¹² is H;
R¹³ is H;
R¹⁴ is H;
R¹⁵ is together with R¹⁶ can form a 3 to 6 membered ring cycloalkyl;
R¹⁶ is together with R¹⁵ can form a 3 to 6 membered ring cycloalkyl;
R¹⁷ is H;
R¹⁸ is H;
R¹⁹ is H;
R²⁰ is H;
R²³ is H; and
R²⁴ is H.

12. The compound according to claim 1, wherein:
n is 1;
L is —CR²³R²⁴—;
R² is H;
R³ is H;
R⁵ is H;
R⁶ is H;
R⁷ is CR^{7a};
R⁸ is H;
R¹⁰ is H;
R¹¹ is H;
R¹² is H;
R¹³ is H;
R¹⁴ is H;
R¹⁵ is H, D, F, C₁₋₄ alkyl or C₁₋₄perfluoroalkyl;
R¹⁶ is H, D, F, C₁₋₄ alkyl or C₁₋₄perfluoroalkyl;
R¹⁷ is H;
R¹⁸ is H;
R¹⁹ is H;
R²⁰ is H;
R²³ is H; and
R²⁴ is H.

13. The compound according to claim 1, wherein:
n is 1;
L is —CR²³R²⁴—;
R² is H;
R³ is H;
R⁵ is H;
R⁶ is H;
R⁷ is CR^{7a};
R⁸ is H;
R¹⁰ is H;
R¹¹ is H;
R¹² is H;
R¹³ is H;
R¹⁴ is H;
R¹⁵ is H, D, F, C₁₋₄ alkyl or C₁₋₄perfluoroalkyl;
R¹⁶ is H, D, F, alkyl or C₁₋₄perfluoroalkyl;
R¹⁷ is H, D, F, C₁₋₄ alkyl;
R¹⁸ is H, D, F, C₁₋₄ alkyl;
R¹⁹ is H;
R²⁰ is H;
R²³ is H; and
R²⁴ is H.

14. The compound according to claim 1, wherein:
n is 0;
L is —C≡C—;
R² is H;
R³ is H;
R⁴ is H;
R⁵ is H;
R⁶ is H;
R⁷ is CR^{7a};
R^{7a} is H;
R⁹ is H;
R¹⁰ is H;
R¹¹ is H;
R¹² is H;
R¹³ is H;
R¹⁴ is H;
R¹⁵ is H;
R¹⁶ is H;
R¹⁷ is H;
R¹⁸ is H;
R¹⁹ is H;
R²⁰ is H;
R²³ is H or D; and
R²⁴ is H or D.

15. A compound according to claim 1 selected from:
(3-{[3-fluoro-4-(6-phenylhex-1-yn-1-yl)benzyl]amino}propyl)phosphonic acid;
(3-{[3-fluoro-4-(6-phenylhex-1-yn-1-yl)benzyl]amino}propyl)phosphonic acid;
(3-{[3-methyl-4-(6-phenylhex-1-yn-1-yl)benzyl]amino}propyl)phosphonic acid;
(3-{[4-(6-phenylhex-1-yn-1-yl)benzyl]amino}propyl)phosphonic acid;
(3-{[3-bromo-4-(6-phenylhex-1-yn-1-yl)benzyl]amino}propyl)phosphonic acid;
(3-{[3-fluoro-4-(6-phenylhexyl)benzyl]amino}propyl)phosphonic acid;
(3-{[3-methyl-4-(6-phenylhexyl)benzyl]amino}propyl)phosphonic acid;
(3-{[4-(6-phenylhexyl)-3-(trifluoromethyl)benzyl]amino}propyl)phosphonic acid;
(3-{[3-chloro-4-(6-phenylhexyl)benzyl]amino}propyl)phosphonic acid;
(3-{[4-(6-phenylhexyl)benzyl]amino}propyl)phosphonic acid;
(3-{[2,5-difluoro-4-(6-phenylhexyl)benzyl]amino}propyl)phosphonic acid;
[3-({3-bromo-4-[(5-phenylpentanoyl)amino]benzyl}amino)propyl]phosphonic acid;
(3-((2,5-difluoro-4-(6-(4-fluorophenyl)hexyl)benzyl)amino)propyl)phosphonic acid;
(3-((3-fluoro-4-(6-(4-fluorophenyl)hexyl)benzyl)amino)propyl)phosphonic acid;
(3-((2,5-difluoro-4-(6-(3-fluorophenyl)hexyl)benzyl)amino)propyl)phosphonic acid;
(3-((2,5-difluoro-4-(6-(2-fluorophenyl)hexyl)benzyl)amino)propyl)phosphonic acid;
(3-((2-bromo-5-fluoro-4-(6-phenylhexyl)benzyl)amino)propyl)phosphonic acid;
(3-((5-fluoro-2-methyl-4-(6-phenylhexyl)benzyl)amino)propyl)phosphonic acid;
(3-((5-chloro-2-fluoro-4-(6-phenylhexyl)benzyl)amino)propyl)phosphonic acid;
(3-((5-bromo-2-fluoro-4-(6-phenylhexyl)benzyl)amino)propyl)phosphonic acid;
(3-((2-fluoro-5-methyl-4-(6-phenylhexyl)benzyl)amino)propyl)phosphonic acid;
(3-(((5-(6-phenylhexyl)pyridin-2-yl)methyl)amino)propyl)phosphonic acid;
(3-(((4-fluoro-5-(6-phenylhexyl)pyridin-2-yl)methyl)amino)propyl)phosphonic acid;
(3-((2-chloro-5-fluoro-4-(6-(4-fluorophenyl)hexyl)benzyl)amino)propyl)phosphonic acid;
(3-((2-bromo-5-fluoro-4-(6-(4-fluorophenyl)hexyl)benzyl)amino)propyl)phosphonic acid;
(3-((5-fluoro-4-(6-(4-fluorophenyl)hexyl)-2-methylbenzyl)amino)propyl)phosphonic acid;
(3-((5-chloro-2-fluoro-4-(6-(4-fluorophenyl)hexyl)benzyl)amino)propyl)phosphonic acid;
(3-((5-bromo-2-fluoro-4-(6-(4-fluorophenyl)hexyl)benzyl)amino)propyl)phosphonic acid;
(3-((2-fluoro-4-(6-(4-fluorophenyl)hexyl)-5-methylbenzyl)amino)propyl)phosphonic acid;
(3-(((4-fluoro-5-(6-(4-fluorophenyl)hexyl)pyridin-2-yl)methyl)amino)propyl)phosphonic acid;
(3-(((5-(6-(4-fluorophenyl)hexyl)pyridin-2-yl)methyl)amino)propyl)phosphonic acid;
(3-((4-(5-(1-phenylcyclohexyl)pentyl)benzyl)amino)propyl)phosphonic acid;
(3-((4-(6-methyl-6-phenylheptyl)benzyl)amino)propyl)phosphonic acid;
(3-((4-(5-(1-phenylcyclopentyl)pentyl)benzyl)amino)propyl)phosphonic acid;
(3-((4-(5-(3-phenyloxetan-3-yl)pentyl)benzyl)amino)propyl)phosphonic acid;
(3-((2,5-difluoro-4-(5-(1-phenylcyclohexyl)pentyl)benzyl)amino)propyl)phosphonic acid;
(3-((3-fluoro-4-(5-(1-phenylcyclohexyl)pentyl)benzyl)amino)propyl)phosphonic acid;
(3-((2,5-difluoro-4-(6-methyl-6-phenylheptyl)benzyl)amino)propyl)phosphonic acid;
(3-((2,5-difluoro-4-(5-(1-phenylcyclopentyl)pentyl)benzyl)amino)propyl)phosphonic acid;
(3-((2,5-difluoro-4-(5-(3-phenyloxetan-3-yl)pentyl)benzyl)amino)propyl)phosphonic acid;
(3-((4-(5,5-dimethyl-6-phenylhexyl)-3-fluorobenzyl)amino)propyl)phosphonic acid;
(3-{[3-fluoro-4-(6-phenylhexyl)benzyl]amino}propyl)phosphonic acid-d₂;
(3-{[3-chloro-4-(6-phenylhexyl)benzyl]amino}propyl)phosphonic acid-d₂;
(3-((3-chloro-2,5-difluoro-4-(6-(4-fluorophenyl)-6-methylheptyl)benzyl)amino) propyl)phosphonic acid;
(3-((3-chloro-4-((5-(4-fluorophenyl)-5-methylhexyl)amino)benzyl)amino)propyl)phosphonic acid;
(3-((3-chloro-4-((4,4-dimethyl-5-phenylpentyl)amino)benzyl)amino)propyl)phosphonic acid;
(3-((3-chloro-4-((4-(3-phenyloxetan-3-yl)butyl)amino)benzyl)amino)propyl)phosphonic acid;
(3-((3-chloro-4-((4-(1-phenylcyclopentyl)butyl)amino)benzyl)amino)propyl)phosphonic acid;
(3-((3-chloro-4-((4-(1-phenylcyclohexyl)butyl)amino)benzyl)amino)propyl)phosphonic acid;
(3-(((4-chloro-5-((5-phenylpentyl)amino)pyridin-2-yl)methyl)amino)propyl)phosphonic acid;
(3-(((4-chloro-5-((5-(4-fluorophenyl)pentyl)amino)pyridin-2-yl)methyl)amino)propyl)phosphonic acid;
(3-((5-chloro-2-fluoro-4-((5-(4-fluorophenyl)pentyl)amino)benzyl)amino)propyl)phosphonic acid;
(3-((3-chloro-4-((5-(4-fluorophenyl)pentyl)amino)benzyl)amino)propyl)phosphonic acid;
(3-((3-chloro-4-((5-(3-fluorophenyl)pentyl)amino)benzyl)amino)propyl)phosphonic acid;
(3-((3-chloro-4-(6-(4-fluorophenyl)-6-methylheptyl)benzyl)amino)propyl)phosphonic acid;
(3-((3-chloro-4-(5,5-dimethyl-6-phenylhexyl)benzyl)amino)propyl)phosphonic acid;
(3-((3-chloro-4-(5-(3-phenyloxetan-3-yl)pentyl)benzyl)amino)propyl)phosphonic acid;
(3-((3-chloro-4-(5-(1-phenylcyclopentyl)pentyl)benzyl)amino)propyl)phosphonic acid;
(3-((3-chloro-4-(5-(1-phenylcyclohexyl)pentyl)benzyl)amino)propyl)phosphonic acid;
(3-(((4-chloro-5-(6-phenylhexyl)pyridin-2-yl)methyl)amino)propyl)phosphonic acid;
(3-(((4-chloro-5-(6-(4-fluorophenyl)hexyl)pyridin-2-yl)methyl)amino)propyl)phosphonic acid;
(3-((5-chloro-2-fluoro-4-(6-(4-fluorophenyl)hexyl)benzyl)amino)propyl)phosphonic acid;
(3-((3-chloro-4-(6-(4-fluorophenyl)hexyl)benzyl)amino)propyl)phosphonic acid;
(3-((3-chloro-4-(6-(3-fluorophenyl)hexyl)benzyl)amino)propyl)phosphonic acid;
(3-((3-chloro-4-((5-(2-fluorophenyl)pentyl)amino)benzyl)amino)propyl)phosphonic acid;
(3-((4-(6-phenylhexyl)-3-(trifluoromethoxy)benzyl)amino)propyl)phosphonic acid;
(3-((4-(6-(p-tolyl)hexyl)-3-(trifluoromethoxy)benzyl)amino)propyl)phosphonic acid;
(3-((4-(5-(1-phenylcyclohexyl)pentyl)-3-(trifluoromethoxy)benzyl)amino)propyl)phosphonic acid;
(3-((3-(perfluoroethyl)-4-(6-phenylhexyl)benzyl)amino)propyl)phosphonic acid;
(3-((3-(perfluoroethyl)-4-(6-(p-tolyl)hexyl)benzyl)amino)propyl)phosphonic acid;
(3-((3-(perfluoroethyl)-4-(5-(1-phenylcyclohexyl)pentyl)benzyl)amino)propyl)phosphonic acid;
(3-((4-((5-phenylpentyl)amino)-3-(trifluoromethoxy)benzyl)amino)propyl)phosphonic acid;
(3-((4-((5-(p-tolyl)pentyl)amino)-3-(trifluoromethoxy)benzyl)amino)propyl)phosphonic acid;
(3-((4-((4-(1-phenylcyclohexyl)butyl)amino)-3-(trifluoromethoxy)benzyl)amino) propyl)phosphonic acid;
(3-((3-(perfluoroethyl)-4-((5-phenylpentyl)amino)benzyl)amino)propyl)phosphonic acid;
(3-((3-(perfluoroethyl)-4-((5-(p-tolyl)pentyl)amino)benzyl)amino)propyl)phosphonic acid;
(3-((3-(perfluoroethyl)-4-((4-(1-phenylcyclohexyl)butyl)amino)benzyl)amino)propyl)phosphonic acid;
(3-((4-(6-(4-fluorophenyl)hexyl)-3-(trifluoromethoxy)benzyl)amino)propyl)phosphonic acid;
(3-((4-(6-(4-fluorophenyl)hexyl)-3-(perfluoroethyl)benzyl)amino)propyl)phosphonic acid;
(3-((4-(5-(1-(4-fluorophenyl)cyclohexyl)pentyl)-3-(trifluoromethoxy)benzyl)amino) propyl)phosphonic acid;
(3-((4-(5-(1-(4-fluorophenyl)cyclohexyl)pentyl)-3-(perfluoroethyl)benzyl)amino) propyl)phosphonic acid;
(3-((4-((5-(4-fluorophenyl)pentyl)amino)-3-(trifluoromethoxy)benzyl)amino)propyl)phosphonic acid;
(3-((4-((5-(4-fluorophenyl)pentyl)amino)-3-(perfluoroethyl)benzyl)amino)propyl)phosphonic acid;
(3-((4-((4-(1-(4-fluorophenyl)cyclohexyl)butyl)amino)-3-(trifluoromethoxy)benzyl)amino) propyl)phosphonic acid;
(3-((4-((4-(1-(4-fluorophenyl)cyclohexyl)butyl)amino)-3-(perfluoroethyl)benzyl)amino) propyl)phosphonic acid;
(3-((4-(6-(4-fluorophenyl)hexyl)-3-(trifluoromethyl)benzyl)amino)propyl)phosphonic acid;
(3-((4-(6-(p-tolyl)hexyl)-3-(trifluoromethyl)benzyl)amino)propyl)phosphonic acid;
(3-((4-(5-(1-phenylcyclohexyl)pentyl)-3-(trifluoromethyl)benzyl)amino)propyl)phosphonic acid;
(3-((4-(5-(1-(4-fluorophenyl)cyclohexyl)pentyl)-3-(trifluoromethyl)benzyl)amino) propyl)phosphonic acid;
(3-((4-((5-phenylpentyl)amino)-3-(trifluoromethyl)benzyl)amino)propyl)phosphonic acid;
(3-((4-((5-(4-fluorophenyl)pentyl)amino)-3-(trifluoromethyl)benzyl)amino)propyl)phosphonic acid;
(3-((4-((5-(p-tolyl)pentyl)amino)-3-(trifluoromethyl)benzyl)amino)propyl)phosphonic acid;
(3-((4-((4-(1-phenylcyclohexyl)butyl)amino)-3-(trifluoromethyl)benzyl)amino)propyl)phosphonic acid;
(3-((4-((4-(1-(4-fluorophenyl)cyclohexyl)butyl)amino)-3-(trifluoromethyl)benzyl)amino)propyl)phosphonic acid;
(3-((3-fluoro-4-(methyl(5-phenylpentyl)amino)benzyl)amino)propyl)phosphonic acid;
(3-((4-(ethyl(5-phenylpentyl)amino)-3-fluorobenzyl)amino)propyl)phosphonic acid;
(3-((3-chloro-4-(methyl(5-phenylpentyl)amino)benzyl)amino)propyl)phosphonic acid;
(3-((3-chloro-4-(ethyl(5-phenylpentyl)amino)benzyl)amino)propyl)phosphonic acid;
(3-((3-methyl-4-(methyl(5-phenylpentyl)amino)benzyl)amino)propyl)phosphonic acid;
(3-((4-(ethyl(5-phenylpentyl)amino)-3-methylbenzyl)amino)propyl)phosphonic acid;
(3-((4-(ethyl(5-(4-fluorophenyl)pentyl)amino)-3-fluorobenzyl)amino)propyl)phosphonic acid;
(3-((3-chloro-4-(ethyl(5-(4-fluorophenyl)pentyl)amino)benzyl)amino)propyl)phosphonic acid; and
(3-((4-(ethyl(5-(4-fluorophenyl)pentyl)amino)-3-methylbenzyl)amino)propyl)phosphonic acid.
